(19) United States
(12) Patent Application Publication
(10) Pub. No.: US 2011/0173292 A1
(43) Pub. Date: Jul. 14, 2011

(54) PUSH BASED INTER-OPERATOR INTER-DEVICE TRANSFER

(75) Inventors: Milan Patel, Middlesex (GB); Kamel M. Shaheen, King of Prussia, PA (US)

(73) Assignee: INTERDIGITAL PATENT HOLDINGS, INC., Wilmington, DE (US)

(21) Appl. No.: 12/987,833

(22) Filed: Jan. 10, 2011

Related U.S. Application Data
(60) Provisional application No. 61/293,916, filed on Jan. 11, 2010.
(60) Provisional application No. 61/293,928, filed on Jan. 11, 2010.
(60) Provisional application No. 61/294,400, filed on Jan. 12, 2010.

(51) Int. Cl. G06F 15/16

(52) U.S. Cl. 709/217

(57) ABSTRACT

Methods and apparatus for push based inter-operator inter-device transfer are described. Methods include anchoring the inter-device transfer signaling at a source operator, and at a target operator. Methods also include subsequent push and pull based inter-device transfers within a target operator.

### CROSS REFERENCE TO RELATED APPLICATIONS

This application claims the benefit of U.S. provisional application Nos. 61/293,916 filed Jan. 11, 2010; 61/293,928 filed Jan. 11, 2010; and 61/294,400 filed Jan. 12, 2010, the contents of which are hereby incorporated by reference herein.

### FIELD OF THE INVENTION

This application is related to wireless communications.

### BACKGROUND

The Internet Protocol (IP) Multimedia Subsystem (IMS) is an architectural framework for delivering IP-based multimedia services. A wireless transmit/receive unit (WTRU) may connect to an IMS through various access networks, including but not limited to networks based on technology such as Universal Mobile Telecommunications System (UMTS) Terrestrial Radio Access Network (UTRAN), Long Term Evolution (LTE), Worldwide Interoperability for Microwave Access (WiMax), or Wireless Local Area Network (WLAN) technology. A WTRU may access the IMS through a packet-switched (PS) domain. Through the use of IMS Centralized Services (ICS), a WTRU may additionally access IMS services via a circuit-switched (CS) domain.

Inter-device transfer (IDT) allows a communication session to be transferred from one device (e.g., a WTRU, a local area network (LAN) or wireless LAN computer, a voice over IP communications device or any other device connected to any communications network via IP) to another.

### SUMMARY

Methods and apparatus for push based inter-operator inter-device transfer are described. Methods include anchoring the inter-device transfer signaling at a source operator, and at a target operator. Methods also include subsequent push and pull based inter-device transfers within a target operator.

### BRIEF DESCRIPTION OF THE DRAWINGS

A more detailed understanding may be had from the following description, given by way of example in conjunction with the accompanying drawings wherein:

FIG. 1A is a system diagram of an example communications system in which one or more disclosed embodiments may be implemented;

FIG. 1B is a system diagram of an example wireless transmit/receive unit (WTRU) that may be used within the communications system illustrated in FIG. 1A;

FIG. 1C is a system diagram of an example radio access network and an example core network that may be used within the communications system illustrated in FIG. 1A;

FIG. 2 shows an inter-device transfer (IDT) within one operator;

FIG. 3 shows a flow diagram for a IDT within one operator;

FIG. 4 shows another flow diagram for a IDT within one operator;

FIG. 5 shows an example inter-operator IDT;

FIG. 6 shows an example diagram of a push based inter-operator IDT that is anchored at a source operator;

FIG. 7 shows an example flow diagram of a push based inter-operator IDT that is anchored at a source operator;

FIG. 8 shows another example flow diagram of a push based inter-operator IDT that is anchored at a source operator;

FIG. 9 shows another example flow diagram of a push based inter-operator IDT that is anchored at a source operator;

FIG. 10 shows another example diagram of a push based inter-operator IDT that is anchored at a source operator;

FIG. 11 shows another example flow diagram of a push based inter-operator IDT that is anchored at a source operator;

FIG. 12 shows another example diagram of a push based inter-operator IDT that is anchored at a source operator;

FIG. 13 shows another example flow diagram of a push based inter-operator IDT that is anchored at a source operator;

FIG. 14 shows an example diagram of a push based inter-operator IDT that is anchored at a target operator;

FIG. 15 shows an example flow diagram of a push based inter-operator IDT that is anchored at a target operator;

FIG. 16 shows another example flow diagram of a push based inter-operator IDT that is anchored at a target operator;

FIG. 17 shows an example diagram of a subsequent push based inter-operator IDT in a target operator;

FIG. 18 shows an example flow diagram of a subsequent push based inter-operator IDT in a target operator;

FIG. 19 shows an example diagram of a subsequent pull based inter-operator IDT in a target operator;

FIG. 20 shows an example flow diagram of a subsequent pull based inter-operator IDT in a target operator;

FIG. 21 shows an example diagram of a subsequent push based inter-operator IDT in a target operator using source operator signaling;

FIG. 22 shows an example flow diagram of a subsequent push based inter-operator IDT in a target operator using source operator signaling; and

FIG. 23 shows an example flow diagram of a subsequent pull based inter-operator IDT in a target operator using source operator signaling.

### DETAILED DESCRIPTION

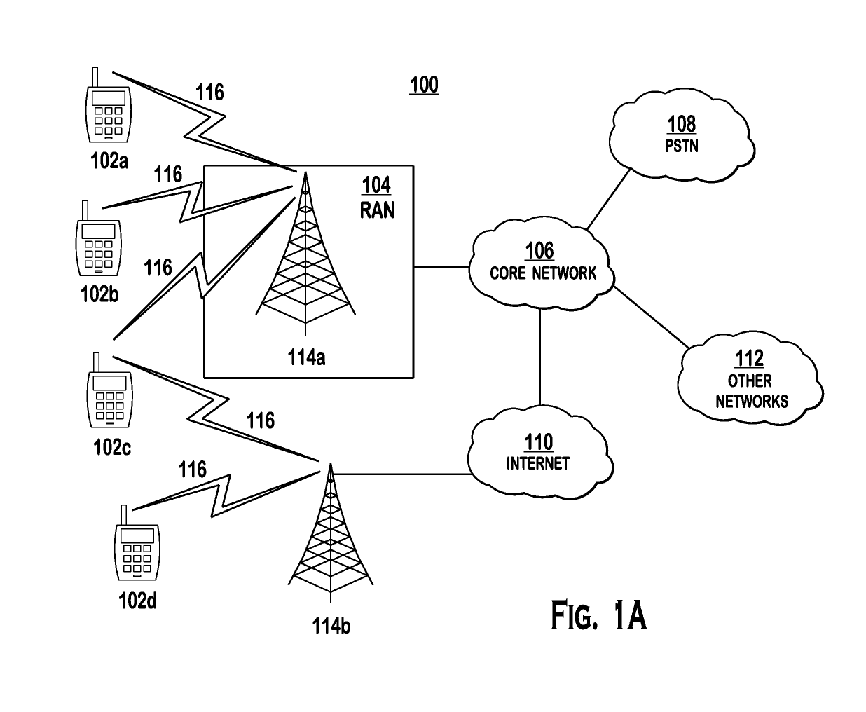

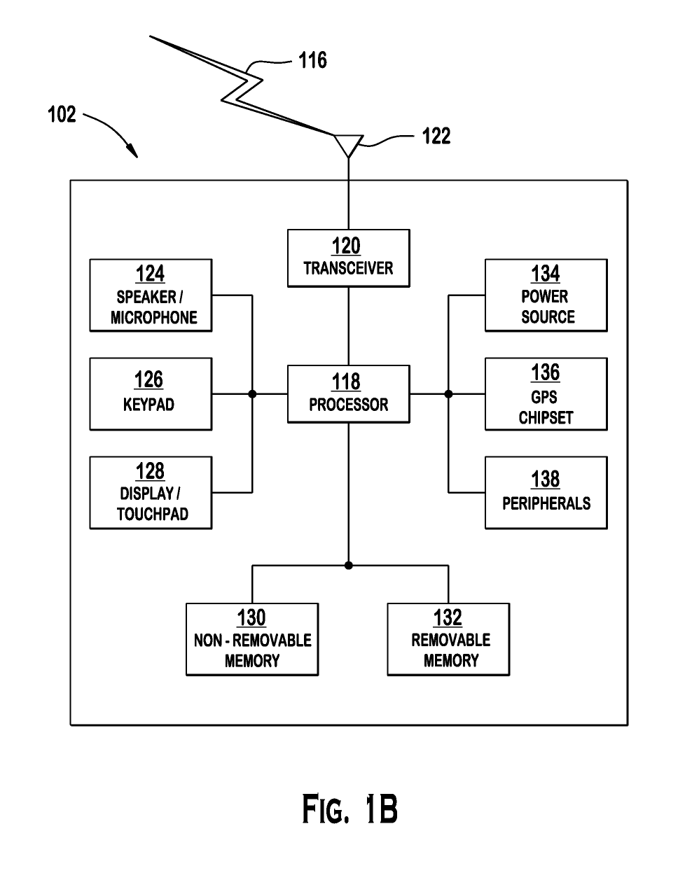

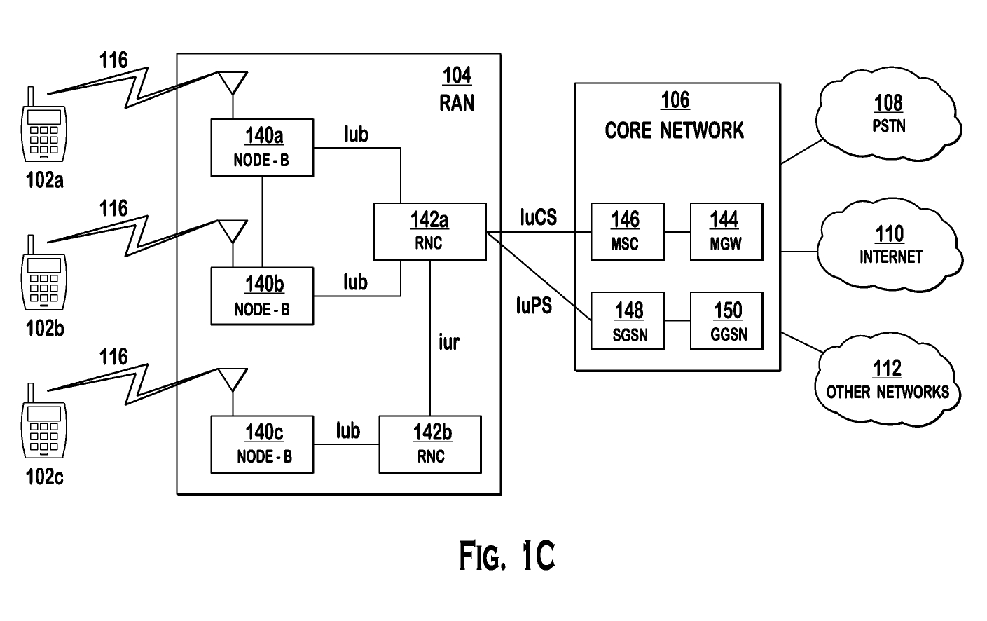

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, 102d, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a touchpad, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals within a particular region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over air interface(s) 116, which may be any suitable wireless communication link (e.g., radio frequency (RF), microwave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

In other embodiments, the base station 114a and the WTRUs 102a, 102b, 102c may implement any combination of the aforementioned radio technologies. For example, the base station 114a and the WTRUs 102a, 102b, 102c may each implement dual radio technologies such as UTRA and E-UTRA, which may concurrently establish one air interface using WCDMA and one air interface using LTE-A respectively.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106.

The RAN 104 may be in communication with the core network 106, which may be any type of network configured to provide voice, data, applications, and/or voice over internet protocol (VoIP) services to one or more of the WTRUs 102a, 102b, 102c, 102d. For example, the core network 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 104 and the core network 106 according to an embodiment. As noted above, the RAN 104 may employ an E-UTRA radio technology to communicate with the WTRUs 102a, 102b, 102c over the air interface 116. The RAN 104 may also be in communication with the core network 106.

The RAN 104 may include eNode-Bs 140a, 140b, 140c, though it will be appreciated that the RAN 104 may include any number of eNode-Bs while remaining consistent with an embodiment. The eNode-Bs 140a, 140b, 140c may each include one or more transceivers for communicating with the WTRUs 102a, 102b, 102c over the air interface 116. In one embodiment, the eNode-Bs 140a, 140b, 140c may implement MIMO technology. Thus, the eNode-B 140a, for example, may use multiple antennas to transmit wireless signals to, and receive wireless signals from, the WTRU 102a.

Each of the eNode-Bs 140a, 140b, 140c may be associated with one or more cells (not shown), each possibly on different carrier frequencies, and may be configured to handle radio resource management decisions, handover decisions, scheduling of users in the uplink and/or downlink, and the like. As shown in FIG. 1C, the eNode-Bs 140a, 140b, 140c may communicate with one another over an X2 interface.

The core network 106 shown in FIG. 1C may include a mobility management gateway (MME) 142, a serving gateway 144, and a packet data network (PDN) gateway 146. While each of the foregoing elements are depicted as part of the core network 106, it will be appreciated that any one of these elements may be owned and/or operated by an entity other than the core network operator.

The MME 142 may be connected to each of the eNode-Bs 142a, 142b, 142c in the RAN 104 via an S1 interface and may serve as a control node. For example, the MME 142 may be responsible for authenticating users of the WTRUs 102a, 102b, 102c, bearer setup/configuration/release, selecting a particular serving gateway during an initial attach of the WTRUs 102a, 102b, 102c, and the like. The MME 142 may also provide a control plane function for switching between the RAN 104 and other RANs (not shown) that employ other radio technologies, such as GSM or WCDMA.

The serving gateway 144 may be connected to each of the eNode Bs 140a, 140b, 140c in the RAN 104 via the S1 interface. The serving gateway 144 may generally route and forward user data packets to/from the WTRUs 102a, 102b, 102c. The serving gateway 144 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 144 may also be connected to the PDN gateway 146, which may provide the WTRUs 102a, 102b, 102c with access to packet-switched networks, such as the Internet 110, to facilitate communications between the WTRUs 102a, 102b, 102c and IP-enabled devices.

The core network 106 may facilitate communications with other networks. For example, the core network 106 may provide the WTRUs 102a, 102b, 102c with access to circuit-switched networks, such as the PSTN 108, to facilitate communications between the WTRUs 102a, 102b, 102c and traditional land-line communications devices. For example, the core network 106 may include, or may communicate with, an IP gateway (e.g., an IP multimedia subsystem (IMS) server) that serves as an interface between the core network 106 and the PSTN 108. In addition, the core network 106 may provide the WTRUs 102a, 102b, 102c with access to the networks 112, which may include other wired or wireless networks that are owned and/or operated by other service providers.

The LTE network shown in FIGS. 1A, 1B and 1C is just one example of a particular communication network and other types of communication networks may be used without exceeding the scope of the present disclosure. For example, the wireless network may be a Universal Mobile Telecommunication System (UMTS) network, a Global System for Mobile communication (GSM) network or a Worldwide Interoperability for Microwave Access (WiMax) network.

When referred to hereafter, the terminology “inter-device transfer (IDT)” includes, but is not limited to, a inter-device media transfer, a communication session transfer, a handoff, a handover, a collaborative session transfer, session mobility, some or all media flows, service control, or any other transfer or duplication of a media flow or control signaling for use in wireless communication.

When referred to hereafter, a device may refer to a device that is capable of communicating using one or more Internet Protocol (IP) Multimedia Subsystem (IMS)-based or IMS-related protocols, such as a device that includes an IMS client. A device may refer to a WTRU, a local area network (LAN) or wireless LAN computer, a voice over internet protocol (IP) communications device or any other device connected to any communications network via IP. A device may be configured to access an IMS via the IMS client and a packet switch (PS) domain or access the IMS via the circuit switch (CS) domain.

Although the examples described herein are with respect to a WTRU, an inter-device transfer (IDT) may allow a communication session as described above to be transferred from one device to another device. The use of WTRU in the examples described herein is for illustrative purposes only.

An IP Multimedia Subsystem (IMS) user may transfer a communication session from one device to another for a number of reasons. For example, the user may want to share the media with another user, take a session or session components and move away from the device that is currently involved in the session, or want to transfer media to devices more capable of handling the media, (i.e. a larger screen, clearer audio, and the like). In addition, the device currently involved in the session may have low battery or poor radio coverage, the remote end device may change media characteristics or add further media and current source device may not function well in the new configuration.

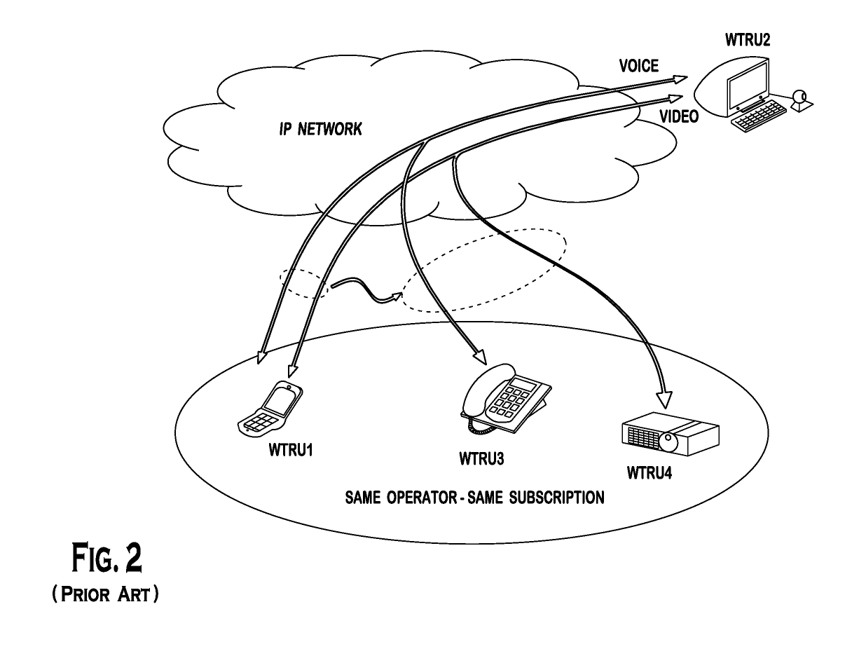

FIGS. 2, 3 and 4 show different perspectives of an IDT within one operator. FIG. 2 shows an overview of a single operator IDT. In particular, FIG. 2 illustrates that an IMS user may have a multimedia session over a device WTRU-1 with voice and video media components. Subsequently, the user may initiate an IDT of the voice component from device WTRU-1 to device WTRU-3 and the transfer of the video component from device WTRU-1 to device WTRU-4. In the examples described herein, an operator may refer to a network, system or the like.

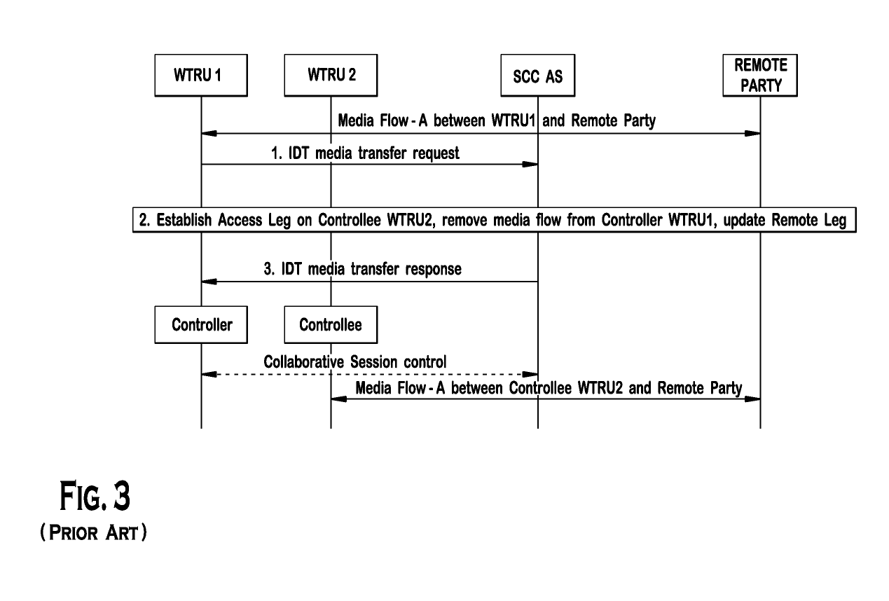

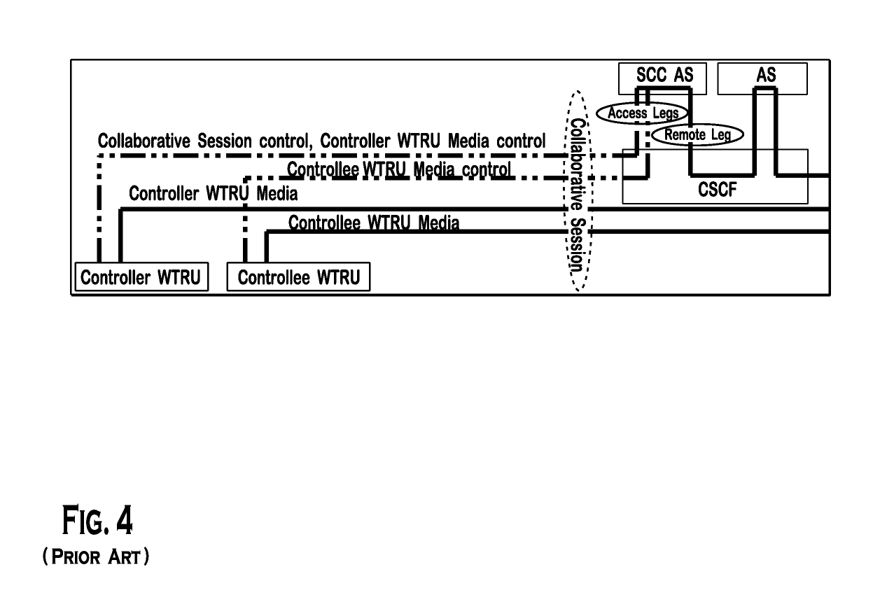

FIGS. 3 and 4 show example flowcharts of a single operator IDT. In general, the two figures show an information flow for a collaborative session establishment procedure when device WTRU-1 initiates media transfer from device WTRU-1 to WTRU-2. After the transfer, the device WTRU-1 becomes a controller device WTRU, and the device WTRU-2 becomes a controllee device WTRU.

In particular, there is an ongoing session between device WTRU-1 and a remote party. The session may be anchored at a Service Centralization and Continuity Application Server (SCC AS). The device WTRU-1 may transfer the media flow from device WTRU-1 to device WTRU-2 to establish a collaborative session. A collaborative session may be a session split across a plurality of device WTRUs and may be anchored in the SCC AS. It may be established in accordance with IDT procedures. The device WTRU that is initiating the IDT in order to establish the collaborative session, becomes the controller device WTRU. Other device WTRUs involved in the collaborative session become controlee device WTRUs. Subsequent IDTs, initiated by the controller device WTRU, may also be performed in the collaborative session. The SCC AS provides coordination of the collaborative session procedures, which may involve both the controller device WTRU and controlee device WTRU. A complete multi-media session may be transferred from one device WTRU to another device WTRU via IDT of the collaborative session.

As shown in FIGS. 3 and 4, there is a media flow-A between device WTRU-1 and a remote party. A device WTRU-1 may then send an IDT media transfer request to the SCC AS to transfer media flow-A from device WTRU-1 to device WTRU-2. The IDT media transfer request may include information to identify that the transferred media flow is media flow-A, identify that the target of the transferred media flow is device WTRU-2, and to keep the control of the collaborative session in device WTRU-1. The SCC AS may then send a request to establish an Access Leg at device WTRU-2 for media flow-A. The SCC AS may then remove media flow-A from device WTRU-1, and update a Remote Leg using a Remote Leg Update procedure. The SCC AS may then send an IDT media transfer response to device WTRU-1. A collaborative session is established, for which device WTRU-1 becomes the controller device WTRU and device WTRU-2 becomes a controllee device WTRU. When the above transfer is complete, the SCC AS retains the service state, (e.g. media flows status) of device WTRU-1 and device WTRU-2, and device WTRU-1 may retain the control of the collaborative session. Device WTRU-1 may transfer other media flows from device WTRU-1 using the procedure above.

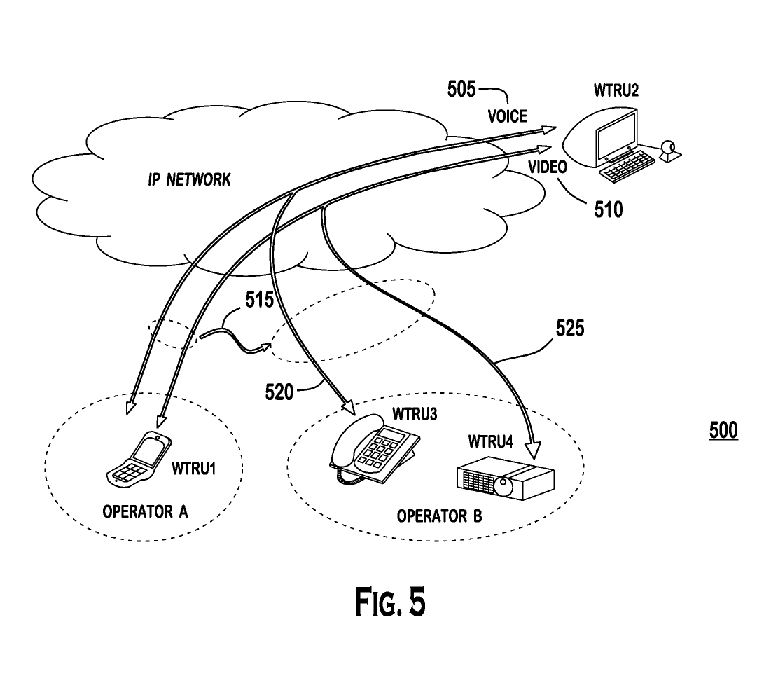

The above describe single operator IDTs. These may not be applicable for inter-operator IDTs. For example, FIG. 5 shows an example diagram 500 overview of an inter-operator IDT. An IMS user may have a multimedia session over a device WTRU-1 subscribed with operator A, having a voice media component 505 and video media component 510. Subsequently, the IMS user may initiate an IDT 515 of the voice media component 505 from device WTRU-1 subscribed in operator A to device WTRU-3 subscribed with operator B (520) and the transfer of the video media component 510 from device WTRU-1 subscribed with operator A to device WTRU-4 subscribed with operator B (525). Methods are needed to perform IDT in multiple operator scenarios.

Described herein are methods for push based inter-operator IDTs that may be anchored at a source operator or at a target operator. In general, a request for IDT may occur from a source WTRU which is already involved in a session that may have signalling pass through a SCC AS A, (acting as a back-to-back user agent (B2BUA)). In the event that a request may be Session Initiation Protocol (SIP) REFER request, the media components to be transferred may be indicated, together with the media component characteristics, (codec, ports and the like). In the event that the IDT request is an offerless INVITE, the media to be transferred may be indicated in a later request. As shown in the examples below and shown for illustrative purposes, the push based inter-operator IDT methods may use REFER messages to SCC AS', REERs to target device WTRUs and INVITE messages for IDT requests. Other messages may also be used. Although the descriptions are with respect to push based transfer requests, they may also be applicable to pull based transfer requests.

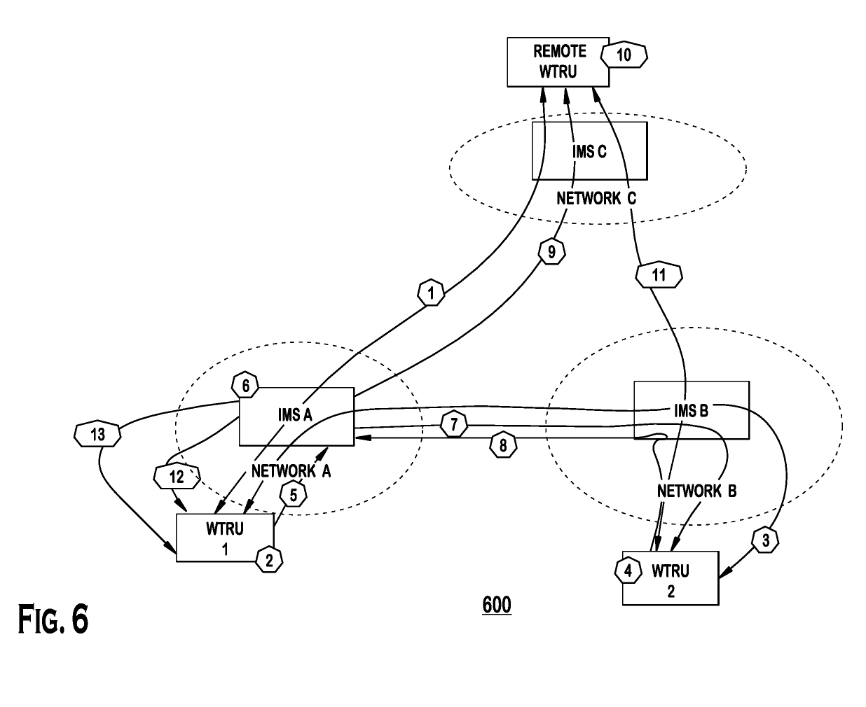

FIG. 6 shows an example diagram 600 of a push based inter-operator IDT that is anchored at a source operator. Initially, a device WTRU1 is in a multimedia session with a remote device WTRU where the session may include more than one media component (1). The device WTRU1 may be subscribed with network A and may interact with IMS A. The IMS A may include multiple entities including, for example, SCC AS A and call session control function (CSCF) A. The remote device WTRU may be subscribed with network C and may interact with IMS C. The device WTRU1 may wish to transfer some media components from the device WTRU1 to a device WTRU2, where the device WTRU2 may be subscribed with a network B and may interact with IMS B (2). IMS B and IMS C may be similar to IMS A. The device WTRU1 may check the device WTRU2's availability and media capabilities (3). If the device WTRU2 is available for the IDT, it may respond to the device WTRU1 with an acknowledgment and media capability information (4). For the diagrams and flow diagrams discussed herein, the capabilities request and response, (i.e., steps (3) and (4) in FIG. 6), may be optional.

The device WTRU1 may initiate an IDT by sending a request to the SCC AS A, (denoted as IMS A) (5). The SCC AS A may anchor the signalling (6) and may send the IDT session establishment request towards device WTRU2 (7). The request may include an offer containing information about the media to be transferred such as, for example, the media type, codecs, and the like. The device WTRU2 may accept and respond with an answer (8). The SCC AS A may update the remote end with the modified session information, including the device WTRU2 IP address, ports and the like for the media transfer to the device WTRU2 (9). The remote device WTRU may accept update and send back a response to acknowledge the session modification (10). A new media path between the device WTRU2 and the remote device WTRU may be established (11). The device WTRU1 may be informed of a successful IDT in response to the initial IDT request (12). The device WTRU1 may be instructed to remove the transferred media from itself since the media has now been transferred to the device WTRU2 (13).

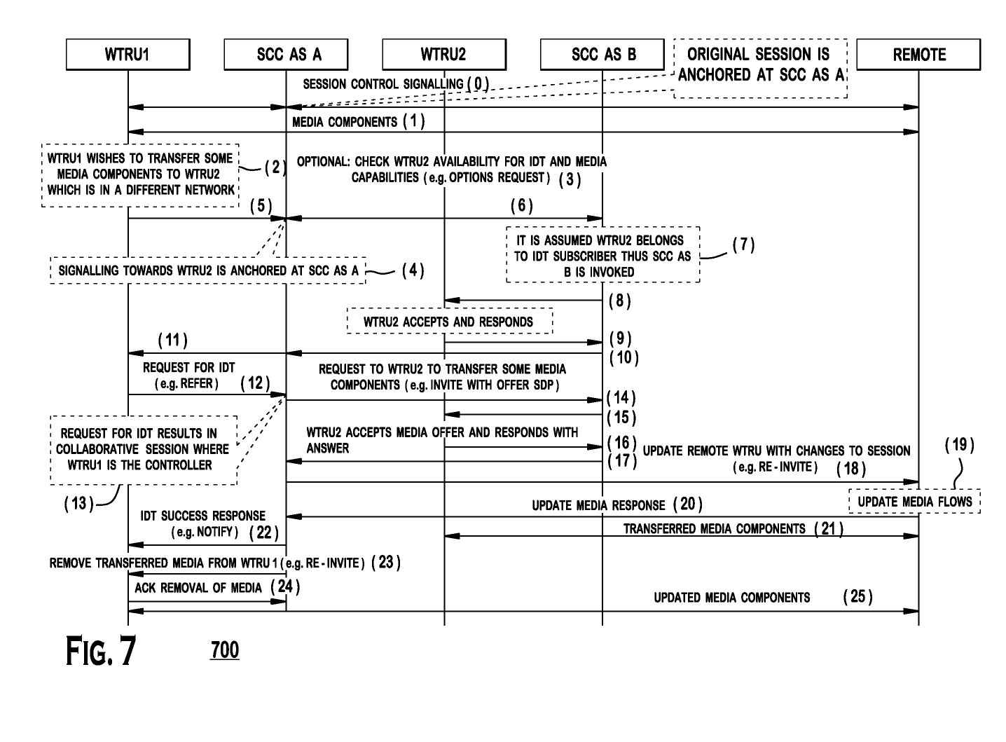

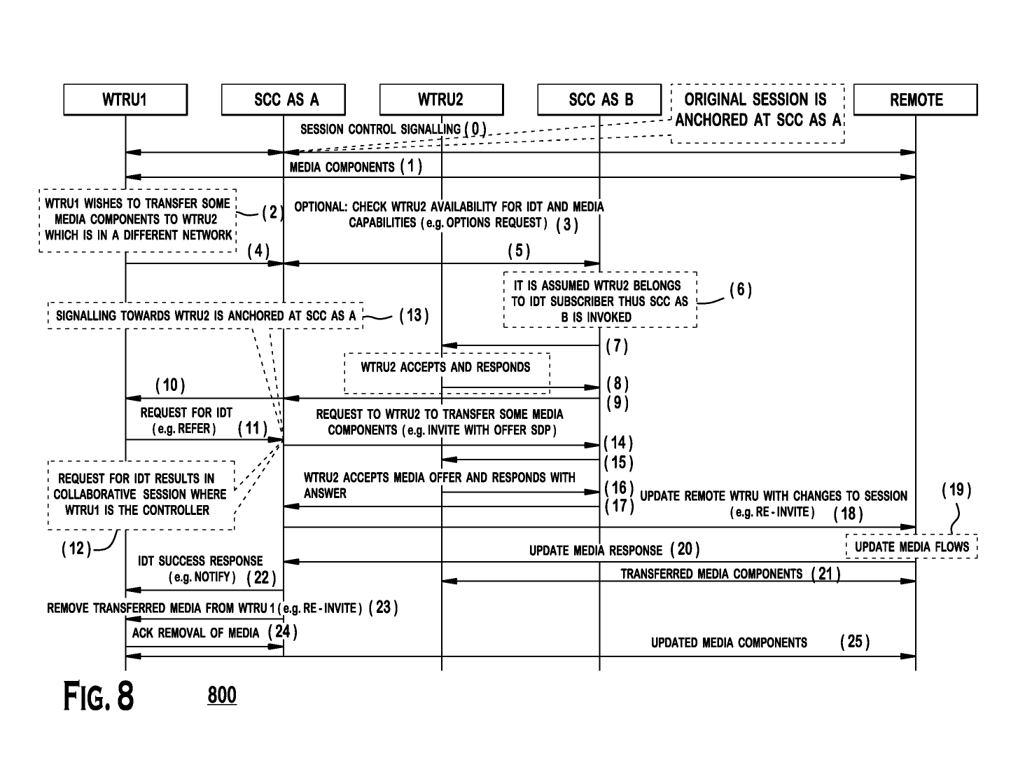

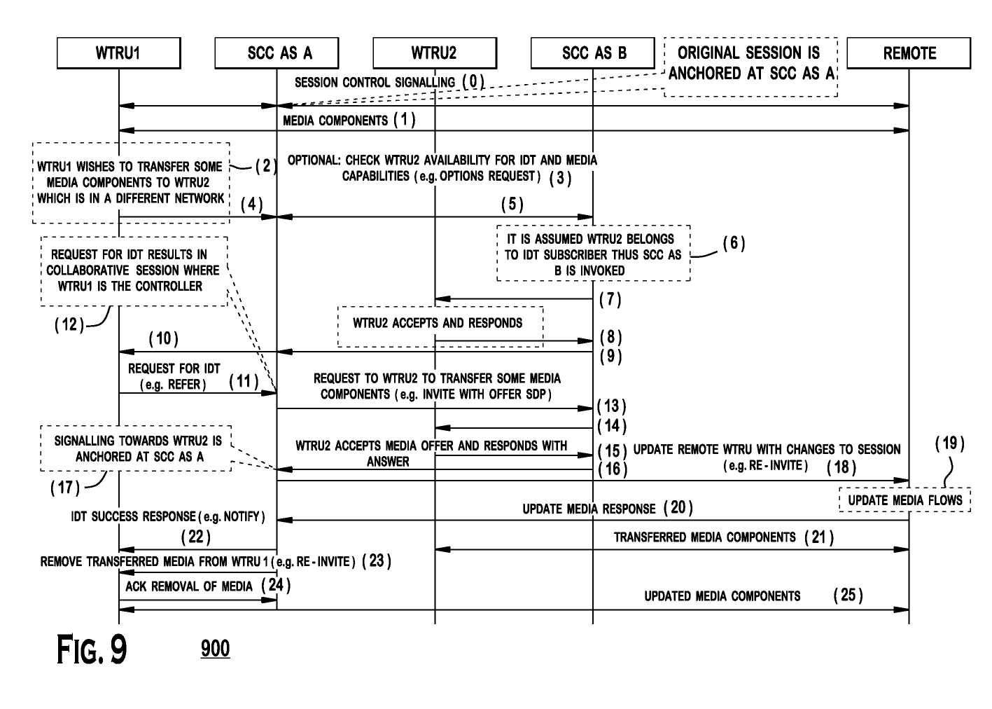

The example push based inter-operator IDT methods described with respect to FIGS. 7, 8 and 9 differ with respect to when the signaling towards the target device is anchored. It may be assumed that the signaling for the original session may be anchored at the SCC AS A, where the source device is subscribed. In particular, the FIG. 7 example method anchors the signaling towards the target device when the target device is queried for IDT availability and media capabilities; the FIG. 8 example method anchors the signaling towards the target device when the SCC AS A receives an IDT request from the source device; and the FIG. 9 example method anchors the signaling towards the target device when the SCC AS A receives a positive response to accept the media to be transferred from the source device. To ensure that the SCC AS A is in the path and performs the B2BUA function, anchoring early may be better.

FIG. 7 shows an example flow diagram 700 of a push based inter-operator IDT method that is anchored at a source operator, i.e., at a SCC AS A. Initially, there is an ongoing session between a device WTRU1 and a remote device WTRU, where the device WTRU1 and the remote device WTRU may send media components information between themselves (1). That is, the media flow may be unidirectional or bidirectional. The device WTRU1 may be subscribed to network A. The ongoing or original session may be anchored at the SCC AS A and session control signaling between the device WTRU1 and the remote device WTRU may be done by the SCC AS A (0).

The device WTRU1 may wish to push some media components from the device WTRU1 to a device WTRU2, where the device WTRU2 may be subscribed with a network B (2). The device WTRU1 may need to check the device WTRU2 IDT availability and media capabilities (3). The IDT signaling toward the device WTRU2 may be anchored at the SCC AS A at the IDT availability and media capabilities request (4). An availability request message may be sent by the device WTRU1 to the SCC AS A (5). For example, the availability request message may be sent via, for example, an OPTIONS request message. The request message may be a SIP OPTIONS message as defined in Request For Comments (RFC) 3261. In general, the SIP OPTIONS message may be a capabilities query which does not result in a dialog. The SCC AS A may send or forward the availability request message to a SCC AS B (6), where the SCC AS B may be invoked as the device WTRU2 is subscribed to network B as discussed above (7). The SCC AS B may send or forward the availability request message to the device WTRU2 (8). The device WTRU2 may accept the availability message request and send a response with IDT availability and media capabilities to the SCC AS B (9). The SCC AS B may send or forward the acceptance and response to the SCC AS A (10), which in turn may send or forward the same to the device WTRU1 (11).

In the event that there is no availability check, then the device WTRU1 may send the request towards the device WTRU2 as described in more detail below. There may be a possibility that the device WTRU2 may reject the request for IDT, or doesn't answer and the request times out. If the device WTRU2 belongs to the same user as the device WTRU1, (but is in a different subscription), the request for IDT is unlikely to be rejected. However, if the device WTRU2 belonged to another user who may be in a different physical location, then the user may reject the IDT request because it may be busy or involved in other session or the like.

The device WTRU1 may then send an IDT request to the SCC AS A (12), where the IDT request may result in a collaborative session where the device WTRU1 may be the controller (13). For example, the IDT request may be sent via a REFER message. The SCC AS A may then send the IDT request to the SCC AS B to transfer some media components from the device WTRU1 to the device WTRU2 (14). For example, this may be done using an INVITE message with offer Session Description Protocol (SDP). The SDP is as defined in RFC 4566. It may be included as the body of a SIP request such as in, for example, an INVITE message, and may used to convey a description of the media associated with the session. In this case, the description of the media to be transferred. A REFER message from SCC AS A to device WTRU2 via SCC AS B may also be possible. In general, when a session request is being sent, it may contain an offer SDP, offering the media description of the session. In a response, an answer SDP may be included to confirm that the media parameters for the session are accepted. The SCC AS B may then send or forward the message to the device WTRU2 (15).

The device WTRU2 may accept the media transfer offer and respond with an answer to the SCC AS B (16), which in turn forwards the same to the SCC AS A (17). The SCC AS A may then update the remote device WTRU with the changes to the session using, for example, a Re-INVITE message (18). The remote device WTRU may update the media flows (19) and may communicate the same to the SCC AS A (20). The device WTRU2 and the remote device WTRU may then transfer media components between themselves (21). The SCC AS A may then inform the device WTRU1 of the successful IDT request via, for example, a NOTIFY message (22). The SCC AS A may also remove the transferred media from the device WTRU1 by sending, for example, a Re-INVITE message to the device WTRU1 (23). The device WTRU1 may then send an acknowledgement (ACK) message to the SCC AS A confirming the removal of the media (24). The device WTRU1 and the remote device WTRU may then update the media components information between themselves (25).

FIG. 8 shows another example flow diagram 800 of a push based inter-operator IDT that is anchored at a source operator, i.e., at a SCC AS A. Initially, there is an ongoing session between a device WTRU1 and a remote device WTRU, where the device WTRU1 and the remote device WTRU may send media components information between themselves (1). That is, the media flow may be unidirectional or bidirectional. The device WTRU1 may be subscribed to network A. The ongoing or original session may be anchored at the SCC AS A and session control signaling between the device WTRU1 and the remote device WTRU may be done by the SCC AS A (0).

The device WTRU1 may wish to push some media components from the device WTRU1 to a device WTRU2, where the device WTRU2 may be subscribed with network B (2). The device WTRU1 may need to check IDT availability and media capabilities of the device WTRU2 (3). An availability request message may then be sent by the device WTRU1 to the SCC AS A (4). For example, the availability message may be sent via an OPTIONS request message. The SCC AS A may send or forward the availability request message to a SCC AS B (5), where the SCC AS B may be invoked as the device WTRU2 may be subscribed to network B as stated above (6). The SCC AS B may send or forward the availability request message to the device WTRU2 (7).

The device WTRU2 may accept the availability request message and send an IDT availability and media capabilities response to the SCC AS B (8). The SCC AS B may send or forward the acceptance and response to the SCC AS A (9), which in turn may send or forward the same to the device WTRU1 (10). The device WTRU1 may then send an IDT request to the SCC AS A (11), where the IDT request may result in a collaborative session where the device WTRU1 may the controller (12). For example, the IDT request may be sent via a REFER message. The IDT signaling toward the device WTRU2 may be anchored at the SCC AS A at the time of the IDT request (13). The SCC AS A may then send the IDT request to the SCC AS B to transfer some media components from device WTRU1 to device WTRU2 (14). For example, this may be done using an INVITE message with offer SDP. The SCC AS B may then send or forward the message to the device WTRU2 (15).

The device WTRU2 may accept the media transfer offer and respond with an answer to the SCC AS B (16), which in turn forwards the same to the SCC AS A (17). The SCC AS A may then update the remote device WTRU with the changes to the session using, for example, a Re-INVITE message (18). The remote device WTRU may update the media flows (19) and may communicate the same to the SCC AS A (20). The device WTRU2 and the remote device WTRU may then transfer media components between themselves (21). The SCC AS A may then inform the device WTRU1 of the successful IDT request via, for example, a NOTIFY message (22). The SCC AS A may also remove the transferred media from the device WTRU1 by sending, for example, a Re-INVITE message to the device WTRU1 (23). The device WTRU1 may then send an acknowledgement (ACK) message to the SCC AS A confirming the removal of the media (24). The device WTRU1 and the remote device WTRU may then update the media components information between themselves (25).

FIG. 9 shows another example flow diagram 900 of a push based inter-operator IDT that is anchored at a source operator, i.e., at SCC AS A. Initially, there is an ongoing session between a device WTRU1 and a remote device WTRU, where the device WTRU1 and the remote device WTRU may send media components information between themselves (1). That is, the media flow may be unidirectional or bidirectional. The device WTRU1 may be subscribed to network A. The ongoing or original session may be anchored at the SCC AS A and session control signaling between the device WTRU1 and the remote device WTRU may be done by the SCC AS A (0).

The device WTRU1 may wish to push some media components from the device WTRU1 to a device WTRU2, where the device WTRU2 may be subscribed with network B (2). The device WTRU1 may need to check IDT availability and media capabilities of device WTRU2 (3). An availability request message may then be sent by the device WTRU1 to SCC AS A (4). For example, the availability message may be sent via an OPTIONS request message. The SCC AS A may send or forward the availability request message to a SCC AS B (5), where the SCC AS B may be invoked as device WTRU2 may be subscribed to operator B (6). The SCC AS B may send or forward the availability request message to the device WTRU2 (7).

The device WTRU2 may accept the availability request message and send a IDT availability and media capabilities response to the SCC AS B (8). The SCC AS B may send or forward the acceptance and response to the SCC AS A (9), which in turn may send or forward the same to the device WTRU1 (10). The device WTRU1 may then send an IDT request to the SCC AS A (11), where the IDT request may result in a collaborative session where the device WTRU1 may the controller (12). For example, the IDT request may be sent via a REFER message. The SCC AS A may then send the IDT request to the SCC AS B to transfer some media components from device WTRU1 to device WTRU2 (13). For example, this may be done using an INVITE message with offer SDP. The SCC AS B may then send or forward the message to the device WTRU2 (14).

The device WTRU2 may accept the media transfer offer and respond with an answer to the SCC AS B (15), which in turn forwards the same to SCC AS A (16). The IDT signaling toward the device WTRU2 may be anchored at SCC AS A in response to the device WTRU2 IDT request acceptance and response (17). The SCC AS A may then update the remote device WTRU with the changes to the session using, for example, a Re-INVITE message (18). The remote device WTRU may update the media flows (19) and may communicate the same to the SCC AS A (20). The device WTRU2 and the remote device WTRU may then transfer media components between themselves (21). The SCC AS A may then inform the device WTRU1 of the successful IDT request via, for example, a NOTIFY message (22). The SCC AS A may also remove the transferred media from the device WTRU1 by sending, for example, a Re-INVITE message to the device WTRU1 (23). The device WTRU1 may then send an acknowledgement (ACK) message to the SCC AS A confirming the removal of the media (24). The device WTRU1 and the remote device WTRU may then update the media components information between themselves (25).

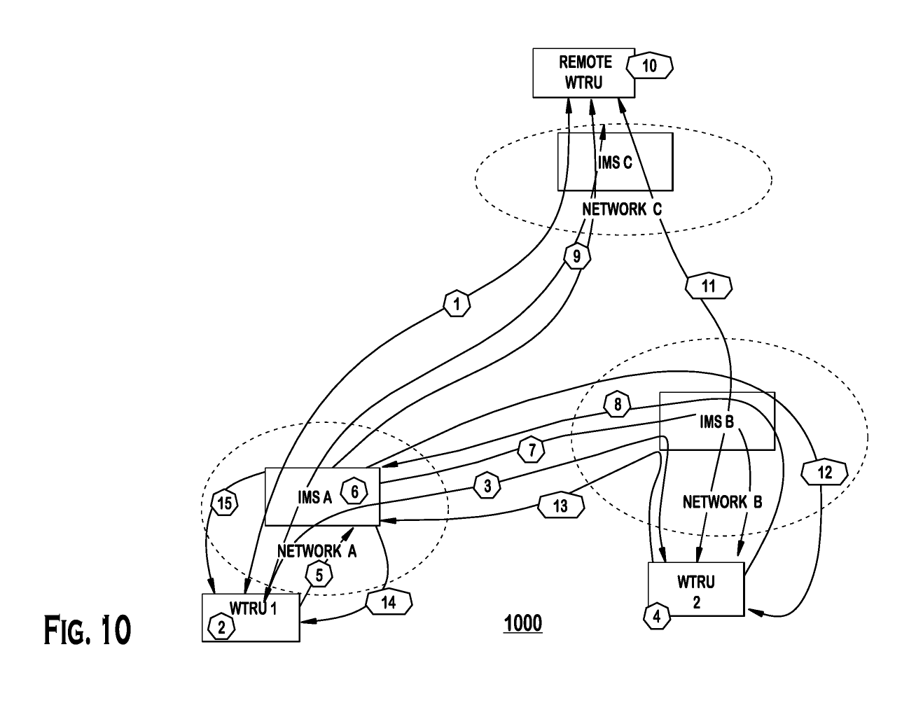

FIG. 10 shows another example diagram 1000 of a push based inter-operator IDT that is anchored at a source operator. Initially, a device WTRU1 is in a multimedia session with a remote device WTRU where the session may include more than one media component (1). The device WTRU1 may be subscribed with network A and may interact with an IMS A. The IMS A may include multiple entities including, for example, SCC AS A and call session control function (CSCF) A. The remote device WTRU may be subscribed with network C and may interact with IMS C. The device WTRU1 may wish to transfer some media components from the device WTRU1 to a device WTRU2, where the device WTRU2 may be subscribed with network B and may interact with IMS B (2). The IMS B and C may be similar to the IMS A. A check for the device WTRU2's IDT availability and media capabilities may be made by the device WTRU1 (3). The device WTRU2 may be available for IDT and may respond to the device WTRU1 with an ACK and media capabilities information (4).

The device WTRU1 may then initiate an IDT by sending a request to the SCC AS A, (denoted as part of IMS A), which indicates the media to be transferred (5). The SCC AS A may anchor the signalling (6) and send the IDT request toward the device WTRU2, where the IDT request may indicate the media to be transferred (7). The device WTRU2 may accept and initiate a session establishment request towards the remote device WTRU (8). The SCC AS A may update the remote device WTRU with the modified session information, including the device WTRU2 IP address, ports and the like for the media to be transferred to the device WTRU2 (9). The remote device WTRU may accept update and send back a response to acknowledge the session modification (10). A new media path between the device WTRU2 and the remote device WTRU may be established (11). A response to the session establishment request may be sent to the device WTRU2 from the SCC AS A (12). The SCC AS A may be informed of a successful IDT in response to the initial IDT request (13), which in turn may notify the device WTRU1, (which may be the controller device WTRU in the IDT) (14). The device WTRU1 may be instructed to remove the transferred media from itself since the media has now been transferred to the device WTRU2 (15).

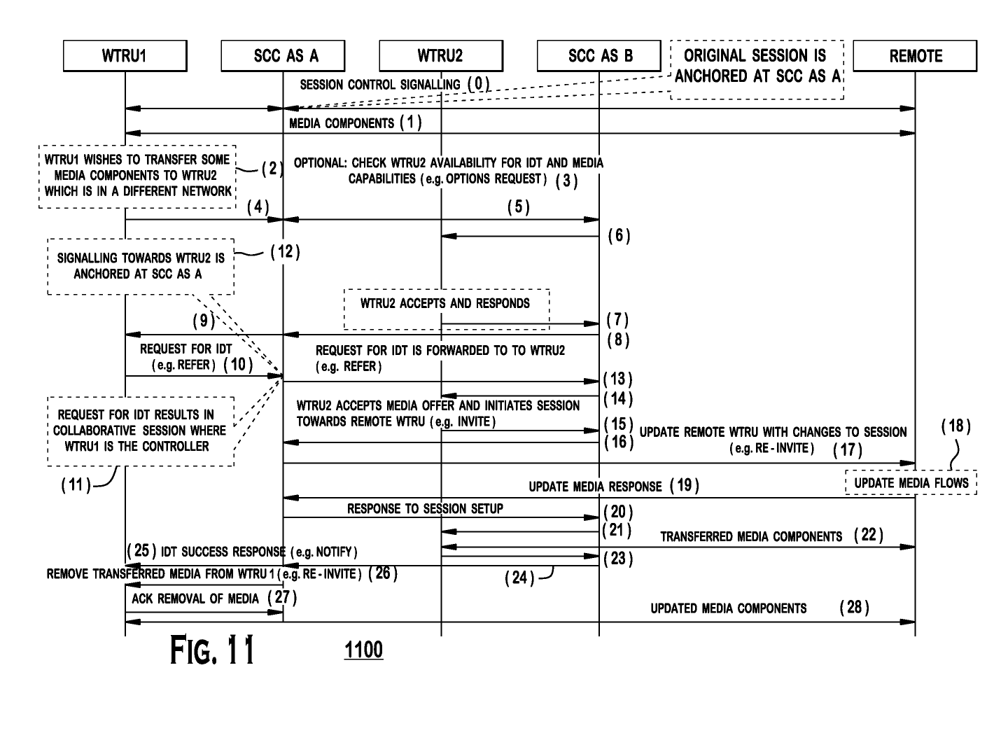

FIG. 11 shows an example flow diagram 1100 of a push based inter-operator IDT method that is anchored at a source operator, i.e., at a SCC AS A. Initially, there is an ongoing session between a device WTRU1 and a remote device WTRU, where the device WTRU1 and the remote device WTRU may send media components information between themselves (1). That is, the media flow may be unidirectional or bidirectional. The device WTRU1 may be subscribed to network A. The ongoing or original session may be anchored at the SCC AS A and session control signaling between the device WTRU1 and the remote device WTRU may be done by the SCC AS A (0).

The device WTRU1 may wish to push some media components from the device WTRU1 to a device WTRU2, where the device WTRU2 may be subscribed with network B (2). The device WTRU1 may need to check IDT availability and media capabilities of the device WTRU2 (3). An availability request message may be sent by the device WTRU1 to the SCC AS A (4). For example, the availability request message may be sent via an OPTIONS request message. The SCC AS A may send or forward the availability request message to the SCC AS B (5), which in turn may send or forward the availability request message to the device WTRU2 (6).

The device WTRU2 may accept the availability request and send an IDT availability and media capabilities response to the SCC AS B (7). The SCC AS B may send or forward the acceptance and response to the SCC AS A (8), which in turn may send or forward the same to the device WTRU1 (9). The device WTRU1 may then send an IDT request to the SCC AS A (10), where the IDT request may result in a collaborative session where device WTRU1 may the controller (11). For example, the IDT request may be sent via a REFER message. The request for IDT contains the information needed by the target device to communicate with the remote device WTRU including for example, IP addresses, media types, ports, codecs and user identity. The IDT signaling toward the device WTRU2 may be anchored at the SCC AS A in response to receipt of the IDT request (12). The SCC AS A may then forward the IDT request to the SCC AS B to transfer some media components from the device WTRU1 to the device WTRU2 (13). For example, this may be done using a REFER message. The SCC AS B may then send or forward the message to the device WTRU2 (14).

The device WTRU2 may accept the media transfer offer and initiate a session towards the remote device WTRU via the SCC AS B (15). This may be done, for example, using an INVITE message. The SCC AS B may send or forward the acceptance and session initiation, (e.g., the INVITE), to SCC AS A (16). The SCC AS A may then update remote device WTRU with the changes to the session using, for example, a Re-INVITE message (17). The remote device WTRU may update the media flows (18) and may communicate the same to the SCC AS A (19). The SCC AS A may then send a response to the initiate session to the SCC AS B (20), which in turn may send or forward the response to the device WTRU2 (21). The device WTRU2 and remote device WTRU may then transfer the media components information between themselves (22). The device WTRU2 may then inform device SCC AS B of the successful IDT request in, for example, a NOTIFY message (23). The SCC AS B may then send or forward the success message to the SCC AS A (24), which in turn may send or forward the message to the device WTRU1 (25). The SCC AS A may also remove the transferred media from the device WTRU1 by sending, for example, a Re-INVITE message to the device WTRU1 (26). The device WTRU1 may then send an ACK message to the SCC AS A confirming the removal of the media (27). The device WTRU1 and the remote device WTRU may then update the media components information between themselves (28).

As shown with respect to FIG. 11, the IDT request may be sent to the SCC AS A, (which acts as a B2BUA), and routes the request towards the target device. This is different from the example shown in FIG. 7, where the SCC AS A terminates the request for the IDT and initiates session establishment request towards the target device. This is done using, for example, an INVITE.

The following example methods may use an INVITE request for the IDT request. The INVITE requests from the controller may be offerless. A response from the target device may contain a SDP offer with all supported media components, ports, IP addresses, codecs and the like. The SCC AS A may use this information to update the remote device WTRU with the target WTRU's contact details for the media components to be transferred. ACK messages from the SCC AS A may include the media parameters used by the remote end.

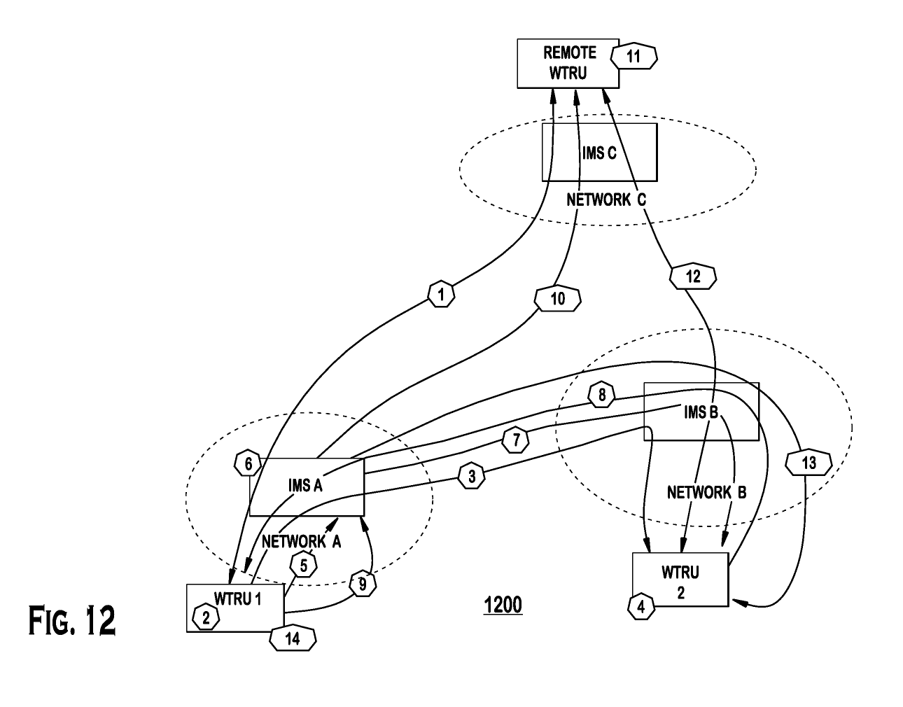

FIG. 12 shows another example diagram 1200 of a push based inter-operator IDT that is anchored at a source operator. Initially, a device WTRU1 is in a multimedia session with a remote device WTRU, where the session may include more than one media component (1). The device WTRU1 may be subscribed with network A and may interact with an IMS A. The IMS A may include multiple entities including, for example, SCC AS A and call session control function (CSCF) A. The remote device WTRU may be subscribed with network C and may interact with an IMS C. The device WTRU1 may wish to transfer some media components from the device WTRU1 to a device WTRU2, where the device WTRU2 may be subscribed with network B and may interact with an IMS B (2). The IMS B and C may be similar to IMS A. The device WTRU1 may check IDT availability and media capabilities for the device WTRU2 and request permission for an IDT (3). The device WTRU2 may be available for IDT and may respond to the device WTRU1 with an ACK and media capabilities information (4).

The device WTRU1 may then initiate an IDT by sending an offerless session establishment request towards the device WTRU2 (5). The SCC AS A may anchor the signalling (6) and send the IDT request towards device WTRU2 (7). The device WTRU2 may accept and respond with an offer indicating the media capabilities of the device WTRU2 including for example, the codes, ports and IP addresses (8). The device WTRU1 may respond with an answer including the media components to be transferred (9). The SCC AS A may update the remote device WTRU with the modified session information, including the device WTRU2 IP address, ports and the like for the media to be transferred to device WTRU2 (10).

The remote device WTRU may accept update and send back a response to acknowledge the session modification (11). A new media path between the device WTRU2 and the remote device WTRU may be established (12). An ACK may be sent that may contain an answer to the offer made by the device WTRU2 in response to the IDT request (13). The device WTRU1 may be instructed to remove the transferred media from itself since the media has now been transferred to device WTRU2 (14).

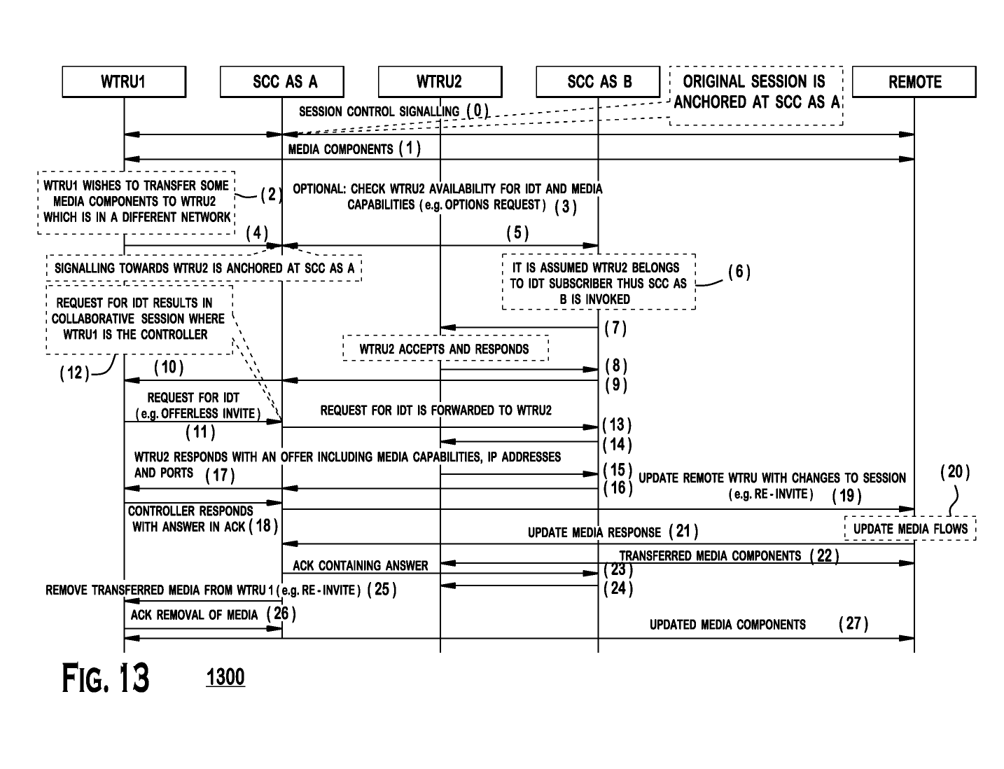

FIG. 13 shows another example flow diagram 1300 of a push based inter-operator IDT method that is anchored at a source operator, i.e., at a SCC AS A. Initially, there is an ongoing session between a device WTRU1 and a remote device WTRU, where the device WTRU1 and the remote device WTRU may send media components information between themselves (1). That is, the media flow may be unidirectional or bidirectional. The device WTRU1 may be subscribed to network A. The ongoing or original session may be anchored at the SCC AS A and session control signaling between the device WTRU1 and the remote device WTRU may be done by the SCC AS A (0).

The device WTRU1 may wish to push some media components from the device WTRU1 to a device WTRU2, where the device WTRU2 may be subscribed with network B (2). The device WTRU1 may need to check IDT availability and media capabilities of the device WTRU2 (3). An availability request message may be sent by the device WTRU1 to the SCC AS A (4). For example, the availability request message may be an OPTIONS request message. The SCC AS A may send or forward the availability request message to the SCC AS B (5), where the SCC AS B may be invoked as device WTRU2 may be subscribed to operator B (6). The SCC AS B may send or forward the availability request message to the device WTRU2 (7). The device WTRU2 may accept the availability message request and send a IDT availability and media capabilities response to the SCC AS B (8). The SCC AS B may send or forward the acceptance and response to SCC AS A (9), which in turn may send or forward the same to the device WTRU1 (10).

The device WTRU1 may send an IDT request to the SCC AS A (11), where the IDT request may result in a collaborative session where device WTRU1 may be the controller (12). For example, the IDT request may be an offerless INVITE message. The SCC AS A may then send the IDT request to the SCC AS B to transfer some media components from the device WTRU1 to the device WTRU2 (13). The SCC AS B may then send or forward the message to device WTRU2 (14).

The device WTRU2 may respond to the SCC AS B with an offer including media capabilities, IP addresses and ports (15). The SCC AS B may then send or forward the response to the SCC AS A (16), which in turn may forward the response to the device WTRU1 (17). The device WTRU1, acting as the controller, may respond with an ACK (18). The SCC AS A may then update the remote device WTRU with the changes to the session using, for example, a Re-INVITE message (19). The remote device WTRU may update the media flows (20) and may communicate the same to the SCC AS A (21). The device WTRU2 and the remote device WTRU may then transfer the media components information between themselves (22). The SCC AS A may then send an ACK containing an answer to SCC AS B (23), which in turn forwards the ACK to device WTRU2 (24). The ACK with answer may be a SIP 200 (OK) response. It may contain a SDP which may be an acceptance by the sender of the response that the media parameters have been negotiated and agreed upon between the device WTRU2 and the remote end. The SCC AS A may also remove the transferred media from the device WTRU1 by sending, for example, a Re-INVITE message to device WTRU1 (25). The device WTRU1 may then send an ACK message to the SCC AS A confirming the removal of the media (26). The device WTRU1 and the remote device WTRU may then update the media components information between themselves (27).

The example methods discussed herein may use the target system as the anchor. In general in these examples, device WTRU1 may be the controller and the initial session may occur between device WTRU1 and the remote device WTRU. Anchoring may occur in the SCC AS A prior to IDT request. However, after the IDT, whether device WTRU1 is the controller or controlee may depend on whether or not anchoring occurs in the target system. If device WTRU2 initiates the IDT, then it may be regarded as the controller. Device WTRU1 may have its signalling anchored at SCC AS A and device WTRU2 may have its signalling anchored at SCC AS B. In this case, the signalling must pass through both SCC AS A and SCC AS B. If the session is anchored at SCC AS A and at SCC AS B, then any mobility that may occur at device WTRUs anchored at SCC AS B, (for example, Access Transfers or even Inter WTRU transfers), may be transparent to the SCC AS A. However, if the IDT occurs between a WTRU anchored on SCC AS B and a WTRU in another network, the SCC AS A must know about such occurrence.

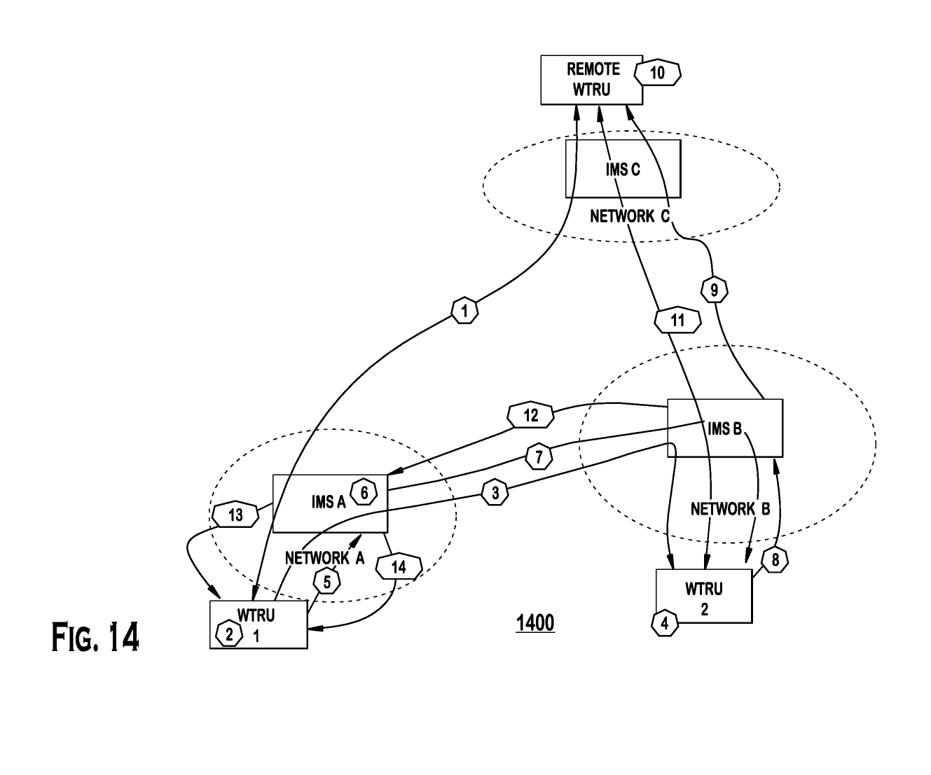

FIG. 14 shows an example diagram 1400 of a push based inter-operator IDT that is anchored at a target source. Initially, a device WTRU1 is in a multimedia session with a remote device WTRU, where the session may include more than one media component (1). The device WTRU1 may be subscribed with network A and may interact with an IMS A. The IMS A may include multiple entities including, for example, SCC AS A and call session control function (CSCF) A. The remote device WTRU may be subscribed with network C and may interact with an IMS C. The device WTRU1 may wish to transfer some media components from the device WTRU1 to a device WTRU2, where the device WTRU2 may be subscribed with network B and may interact with an IMS B (2). The IMS C and B may be similar to the IMS A. The device WTRU1 may check device WTRU2's IDT availability and media capabilities and request permission for an IDT (3). At this time, it may also be negotiated that the SCC AS B may become the anchor for the IDT. The device WTRU2 may be available for IDT and may respond to device WTRU1 with an acknowledgment and media capabilities information (4).

The device WTRU1 may then initiate an IDT by sending a request to SCC AS A that indicates which media may be transferred (5). The SCC AS A may anchor the signalling (6) and send a session establishment request towards the device WTRU2 with an offer containing the media to be transferred (7). The device WTRU2 may accept and initiate a session establishment request toward the remote device WTRU (8). The SCC AS B may send the session request to the remote device WTRU (9). The remote device WTRU may accept the update and send back a response to acknowledge the session modification (10). A new media path between device WTRU2 and remote device WTRU may be established (11). SCC AS B may send a response to the session setup request to SCC AS A (12). SCC AS A may send a successful IDT response to notify the device WTRU1 (13). The device WTRU1 may be instructed to remove the transferred media from itself since the media has now been transferred to device WTRU2 (14).

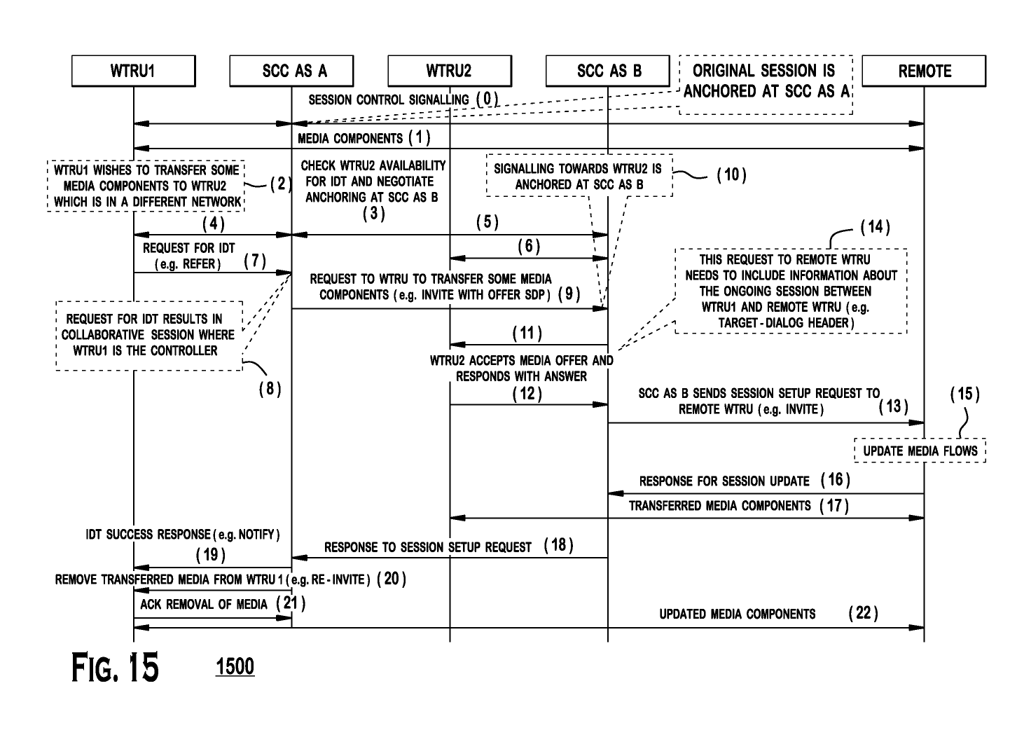

FIG. 15 shows an example flow diagram 1500 of a push based inter-operator IDT method that is anchored at a target operator. Initially, there is an ongoing session between a device WTRU1 and a remote device WTRU, where the device WTRU1 and the remote device WTRU may send media components information between themselves (1). That is, the media flow may be unidirectional or bidirectional. The device WTRU1 may be subscribed to network A. The ongoing or original session may be anchored at a SCC AS A and session control signaling between the device WTRU1 and the remote device WTRU may be done by the SCC AS A (0).

The device WTRU1 may wish to push some media components from device WTRU1 to a device WTRU2, where the device WTRU2 may be subscribed with network B (2). The device WTRU1 may need to check device WTRU2 IDT availability and media capabilities and negotiate SCC AS B as an anchor for the IDT (3). Messages may be sent between the device WTRU1 and SCC AS A (4), between the SCC AS A and SCC AS B (5) and between the SCC AS B and the device WTRU2 (6) to accomplish same.

The device WTRU1 may send an IDT request to SCC AS A (7), where the IDT request may result in a collaborative session where the device WTRU1 may be the controller (8). This message may be sent using, for example, a REFER message. The SCC AS A may then send the IDT request to the SCC AS B to transfer some media components from the device WTRU1 to the device WTRU2 (9). This may be, for example, using an INVITE message with offer SDP. As stated earlier, the IDT is anchored at the target network and the device WTRU2 signaling may be done at the SCC AS B (10). The SCC AS B may then send or forward the message to the device WTRU2 (11).

The device WTRU2 may accept the media offer and respond with an answer to SCC AS B (12). The SCC AS B may then send a session setup request to remote device WTRU in response to receiving the answer (13). This may be done, for example, using an INVITE message. The request may be an update request to the remote end to inform the remote end of the change in destination for the media that is being transferred. The request may include information about the ongoing session between the device WTRU1 and the remote device WTRU, (e.g., a target-dialog header) (14) The target-dialog header field may be a SIP extension defined in RFC 4538. It may be used in requests that create dialogs such as an INVITE, and may used to indicate to the recipient that the sender is aware of an existing dialog with the recipient, either because the sender is on the other side of that dialog, or because it has access to dialog identifiers. The recipient may then authorize the request based on this awareness. Each dialog/session may be uniquely identified by a dialog-ID and other information such as the calling party and called party.

The remote device WTRU may update the media flows (15) and may communicate a session update response to the SCC AS B (16). The device WTRU2 and the remote device WTRU may transfer the media components information between themselves (17). The SCC AS B may send a response to the session setup request to the SCC AS A in view of the remote device WTRU's acceptance and okay of the transfer (18). The SCC AS A, in turn, may send an IDT success response to the device WTRU1 (19). This may be done, for example, using a NOTIFY message. The SCC AS A may also remove the transferred media from the device WTRU1 by sending, for example, a Re-INVITE message, to the device WTRU1 (20). The device WTRU1 may then send an ACK message to the SCC AS A confirming the removal of the media (21). The device WTRU1 and the remote device WTRU may then update the media components information between themselves (22).

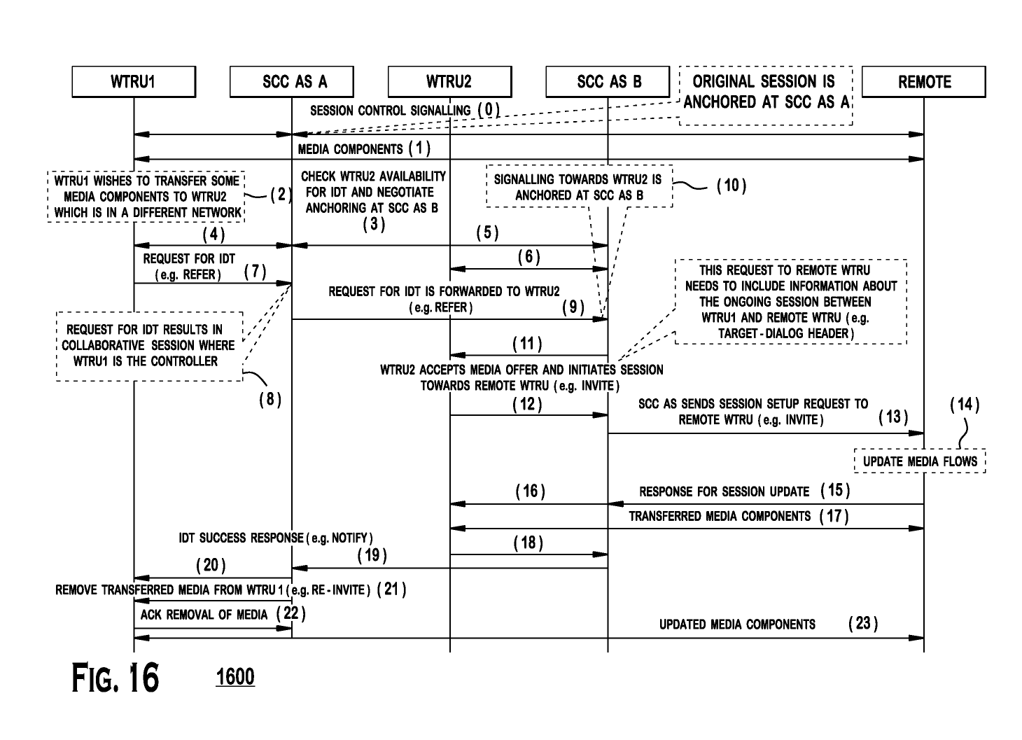

FIG. 16 shows another example flow diagram 1600 of a push based inter-operator IDT method that is anchored at a target operator. Initially, there is an ongoing session between a device WTRU1 and a remote device WTRU, where the device WTRU1 and the remote device WTRU may send media components information between themselves (1). That is, the media flow may be unidirectional or bidirectional. The device WTRU1 may be subscribed to network A. The ongoing or original session may be anchored at a SCC AS A and session control signaling between the device WTRU1 and the remote device WTRU may be done by the SCC AS A (0).

The device WTRU1 may wish to push some media components from the device WTRU1 to a device WTRU2, where the device WTRU2 may be subscribed with network B (2). The device WTRU1 may need to check the device WTRU2 IDT availability and media capabilities and negotiate SCC AS B as an anchor for the IDT (3). Messages may be sent between the device WTRU1 and SCC AS A (4), between the SCC AS A and SCC AS B (5) and between the SCC AS B and the device WTRU2 (6) to accomplish same.

The device WTRU1 may then send an IDT request to the SCC AS A (7), where the IDT request may result in a collaborative session where the device WTRU1 may be the controller (8). This may be done, for example, using a REFER message. The SCC AS A may then forward the IDT request to the SCC AS B (9). This may be, for example, using a REFER message. As stated earlier, the IDT is anchored at the target network and device WTRU2 signaling is done at SCC AS B (10). The SCC AS B may then send or forward the IDT request to the device WTRU2 (11).

The device WTRU2 may accept the media offer and initiate a session towards the remote device WTRU via SCC AS B (12). This may be done, for example, using an INVITE message. The SCC AS B may then send a session setup request to remote device WTRU (13). This may be done, for example, using an INVITE message. The request may include information about the ongoing session between the device WTRU1 and the remote device WTRU, (e.g., a target-dialog header). The remote device WTRU may update the media flows (14) and may communicate a session update response to the SCC AS B (15), which in turn forwards the response to the device WTRU2 (16). The device WTRU2 and the remote device WTRU may then transfer the media components information between themselves (17).

The device WTRU2 may then send an IDT success response to the device WTRU1 via SCC AS B (18), SCC AS A (19) and finally to the device WTRU1 (20). The SCC AS A may remove the transferred media from the device WTRU1 by sending, for example, a Re-INVITE message, to the device WTRU1 (21). The device WTRU1 may then send an ACK message to the SCC AS A confirming the removal of the media (22). The device WTRU1 and the remote device WTRU may then update the media components information between themselves (23).

The example methods described herein show subsequent IDT of media within the target network. In particular, after an initial IDT of media components from a source device WTRU to a target device WTRU, further IDTs may occur between the target device WTRU and another device WTRU within the target network. In such a scenario, the IDT signaling may be localized to the target network with subsequent updates to the source network and controller device WTRU once the IDT is completed. The original target device WTRU, acting as a transferee in the overall session, may act like a transferor for the IDT between itself and another device WTRU within the target network.

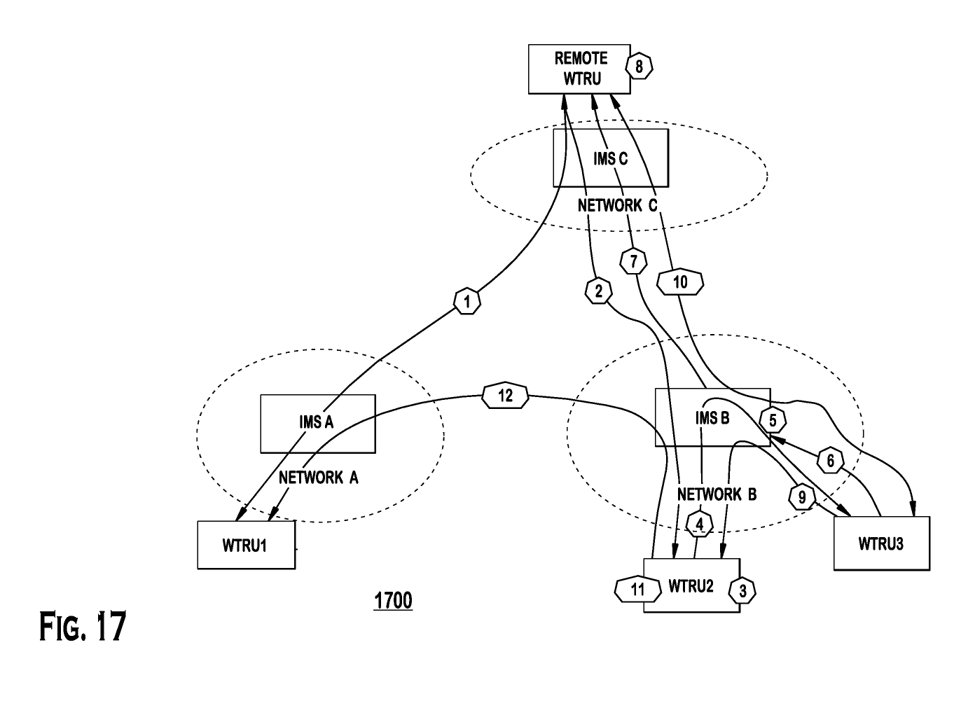

FIG. 17 shows an example diagram 1700 of a subsequent push based inter-operator IDT in a target operator. Initially, a device WTRU1 is in a multimedia session with a remote device WTRU, where the session may include more than one media component (1). The device WTRU1 may be subscribed with network A and may interact with an IMS A, a device WTRU2 may be subscribed with a network B and may interact with an IMS B and a remote device WTRU may be subscribed with a network C and may interact with IMS C. The IMS A may include multiple entities including, for example, SCC AS A and call session control function (CSCF) A. The IMS B and C may be similar to the IMS A. The device WTRU1 may have established a collaborative session with the device WTRU2 by transferring some media components to the device WTRU2, where signaling may be anchored at the SCC AS A (2).

The device WTRU2 may wish to transfer some media components from the device WTRU2 to a device WTRU3, where the device WTRU3 may be subscribed with network B (3). A check for device WTRU3's availability and media capabilities may be made by the device WTRU2.

The device WTRU2 may initiate an IDT towards the device WTRU3 via a SCC AS B (4). The SCC AS B may anchor the signalling between the device WTRU2 and the device WTRU3 (5). The device WTRU3 may request media transfer by sending a request towards the remote device WTRU (6). The SCC AS B may initiate an update towards the remote device WTRU requesting that some media may be sent to the device WTRU3 (7). The remote device WTRU may accept the update and send back a response to acknowledge the session modification (8). The device WTRU3 may indicate a successful transfer of media (9). A new media path between the device WTRU3 and the remote device WTRU may be established (10). The transferred media components from the device WTRU2 may be removed (11). The device WTRU1, (the controller), and the SCC AS A may be updated regarding the media transfer (12).

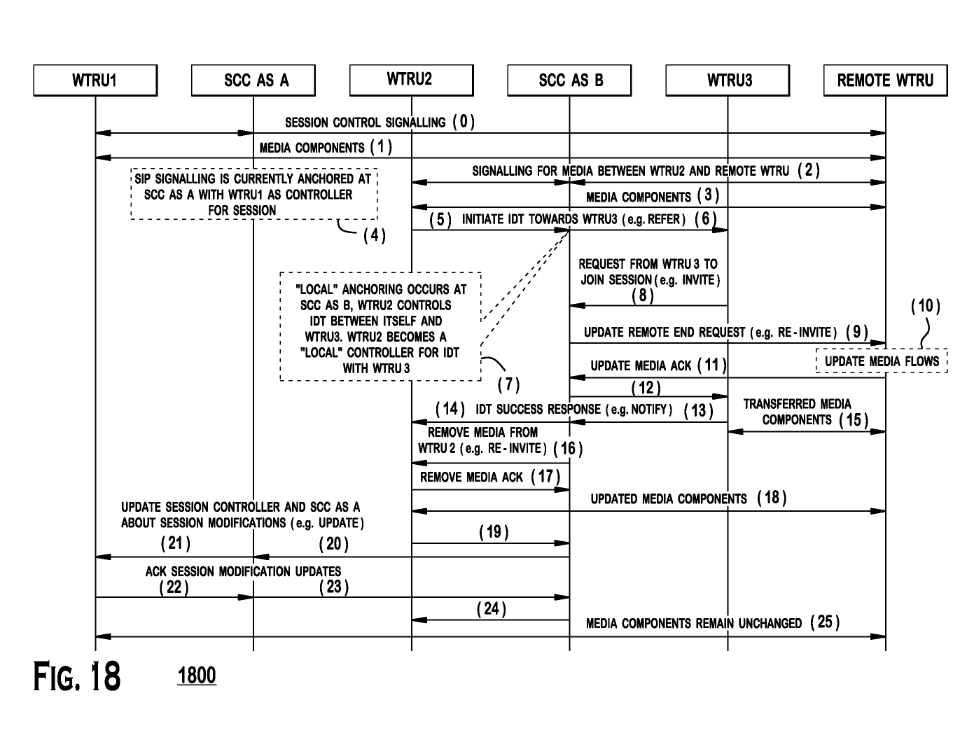

FIG. 18 shows an example flow diagram 1800 of a subsequent push based inter-operator IDT in a target operator. Initially, there is an ongoing session between a device WTRU1 and a remote device WTRU, where the device WTRU1 and the remote device WTRU may send media components information between themselves (1). That is, the media flow may be unidirectional or bidirectional. The device WTRU1 may be subscribed to network A. The ongoing or original session may be anchored at a SCC AS A and session control signaling between the device WTRU1 and the remote device WTRU may be done by the SCC AS A (0). The device WTRU1 may have established a collaborative session with a device WTRU2 by transferring some media components to the device WTRU2 (3), where signaling may be done via a SCC AS B (2). Session initiation protocol (SIP) signaling may be anchored at the SCC AS A with the device WTRU1 as the controller for the session (4).

The device WTRU2 may wish to push some media components from the device WTRU2 to a device WTRU3, where the device WTRU3 may be subscribed with network B. The device WTRU2 may send an initiate message to SCC AS B (5), which in turn sends or forwards the initiate message to device WTRU3 (6). The initiate message may be sent using, for example, a REFER message. Local anchoring may now occur at the SCC AS B (7). In particular, the device WTRU2 may control the IDT between the device WTRU2 and the device WTRU3. The device WTRU2 may become a local controller for the IDT with the device WTRU3.

The device WTRU3 may send a request to the SCC AS B to join the session (8). The request may be sent using, for example, an INVITE message. The SCC AS B may send an update remote end request to the remote device WTRU (9). The remote device WTRU may then update the media flows (10) and may send an update media ACK to the SCC AS B (11), which may then forward the ACK to the device WTRU3 (12).

The device WTRU3 may then send an IDT success response to the SCC AS B (13), which in turn may send or forward the response to the device WTRU2 (14). The response may be sent via, for example, a NOTIFY message. The device WTRU3 and the remote device WTRU may transfer the media components information between themselves (15).

The SCC AS B may remove the transferred media from the device WTRU2 by sending, for example, a Re-INVITE message, to device WTRU2 (16). The device WTRU2 may then send an ACK message to the SCC AS B confirming the removal of the media (17). The device WTRU2 and the remote device WTRU may then update the media components information between themselves (18).

The device WTRU2 may send an update session controller and SCC AS A message regarding the session modifications to the SCC AS B (19), which in turn may send or forward the message to SCC AS A (20). SCC AS A may then forward or send the message to the device WTRU1 (21). The message may be sent via, for example, an UPDATE message. The device WTRU1 may then send a session modification update ACK to the SCC AS A (22), which in turn may send or forward the ACK to the SCC AS B (23). The SCC AS B may then send or forward the ACK to the device WTRU2 (24). The media components remain unchanged between the device WTRU1 and the remote device WTRU (25).

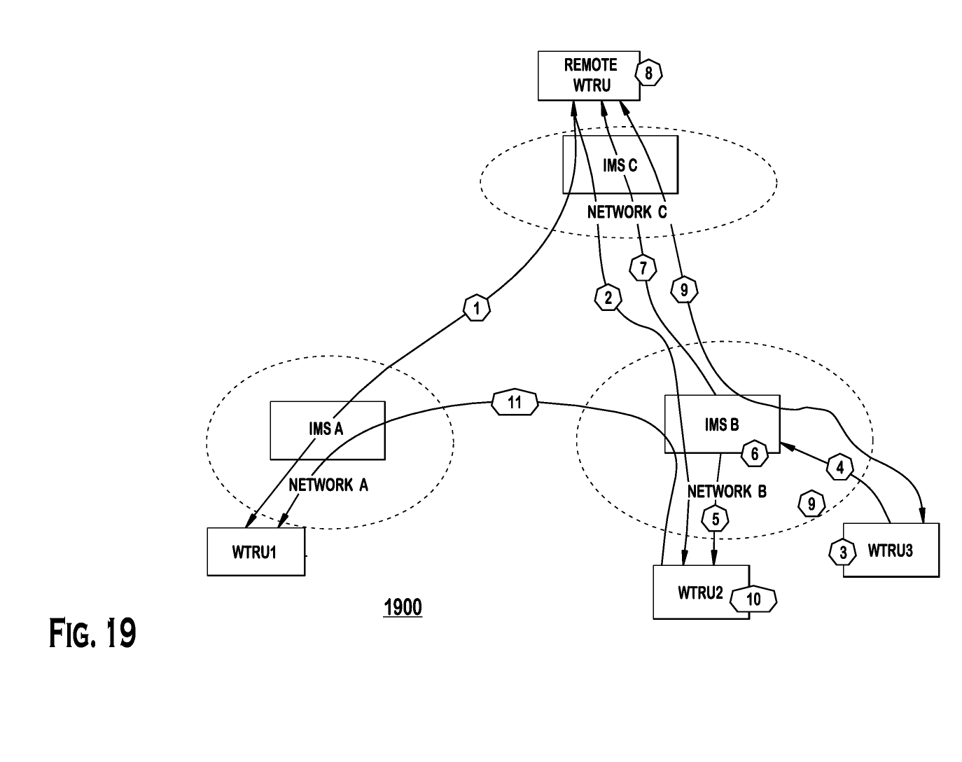

FIG. 19 shows an example diagram 1900 of a subsequent pull based inter-operator IDT in a target operator. Initially, a device WTRU1 is in a multimedia session with a remote device WTRU, where the session may include more than one media component (1). The device WTRU1 may be subscribed with network A and may interact with an IMS A, a device WTRU2 may be subscribed with a network B and may interact with an IMS B and a remote device WTRU may be subscribed with a network C and may interact with IMS C. The IMS A may include multiple entities including, for example, SCC AS A and call session control function (CSCF) A. The IMS B and C may be similar to the IMS A. The device WTRU1 may have established a collaborative session with the device WTRU2 by transferring some media components to the device WTRU2, where signaling may be anchored at a SCC AS A (2). A device WTRU3 may wish to pull some media components from the device WTRU2 to the device WTRU3, where the device WTRU3 may be subscribed with network B (3).

The device WTRU3 may initiate an IDT request towards the remote end to indicate that the device WTRU3 may be an endpoint for some of the media in the ongoing session (4). A request for IDT permission may be sent to the device WTRU2 and the device WTRU2 may grant permission for the IDT (5). A SCC AS B may anchor the signalling between the device WTRU2 and the device WTRU3 (6). The SCC AS B may initiate an update towards the remote device WTRU requesting that some media may be sent to the device WTRU3 (7). The remote device WTRU may accept the update and send back a response to acknowledge the session modification (8). A new media path between the device WTRU3 and the remote device WTRU may be established (9). The transferred media components from the device WTRU2 may be removed (10). The device WTRU1, (the controller), and the SCC AS A may be updated regarding the media transfer (11).

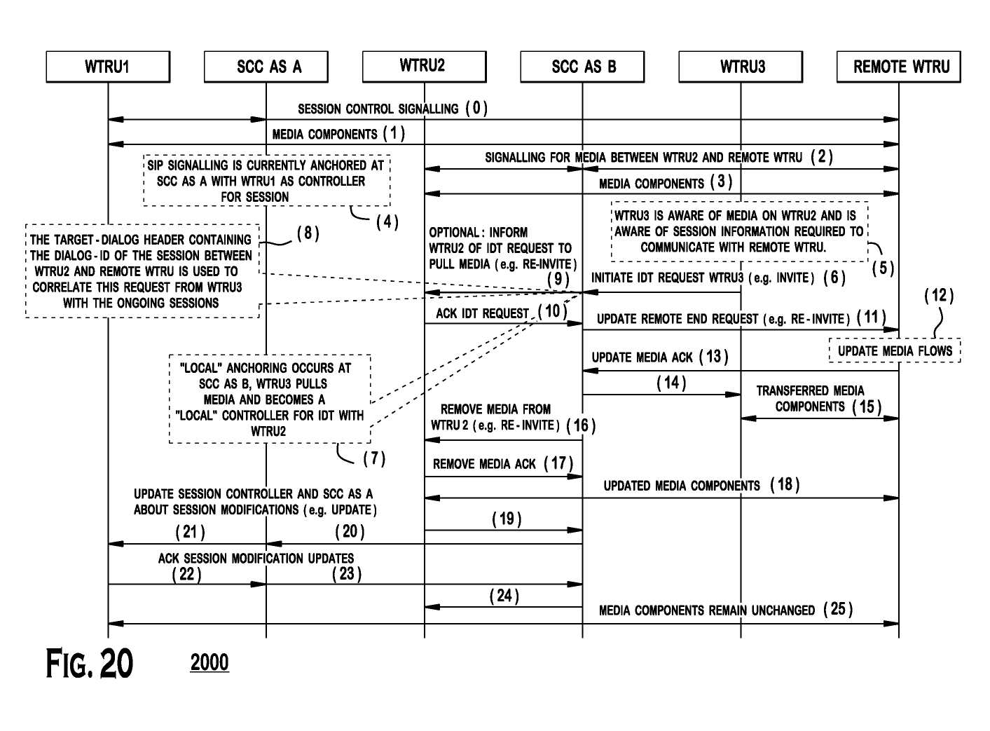

FIG. 20 shows an example flow diagram 2000 of a subsequent pull based inter-operator IDT in a target operator. Initially, there is an ongoing session between a device WTRU1 and a remote device WTRU, where the device WTRU1 and the remote device WTRU may send media components information between themselves (1). That is, the media flow may be unidirectional or bidirectional. The device WTRU1 may be subscribed to network A. The ongoing or original session may be anchored at a SCC AS A and session control signaling between the device WTRU1 and the remote device WTRU may be done by the SCC AS A (0). The device WTRU1 may have established a collaborative session with a device WTRU2 by transferring some media components to the device WTRU2 (3), where signaling may be done via a SCC AS B (2). SIP signaling may be anchored at the SCC AS A with the device WTRU1 as the controller for the session (4).

A device WTRU3 may be aware of media on the device WTRU2 and may be aware of session information needed to communicate with the remote device WTRU (5). The device WTRU3 may initiate an IDT request by sending for example, an INVITE message to the SCC AS B (6). Local anchoring may now occur at the SCC AS B (7). In particular, the device WTRU3 may pull media and become a local controller for the IDT with the device WTRU2. The target dialog header containing the dialog ID of the session between the device WTRU2 and the remote device WTRU may be used to correlate a request made by the device WTRU3 within the ongoing session (8). The SCC AS B may inform the device WTRU2 of the IDT request to pull media (9). This may be done using, for example, a Re-INVITE message. The device WTRU2 may send an ACK for the IDT request (10). In another example, steps (9) and (10) may be optional. In that instance, the device WTRU3 may be pulling the media flow from the device WTRU2 without the device WTRU2's permission.

The SCC AS B may send an update remote end request to the remote device WTRU (11). This may be using, for example, a Re-INVITE. The remote device WTRU may then update the media flows (12) and may send an update media ACK to the SCC AS B (13), which may then forward the ACK to the device WTRU3 (14). The device WTRU3 and the remote device WTRU may transfer the media components information between themselves (15).

The SCC AS B may remove the transferred media from the device WTRU2 by sending, for example, a Re-INVITE message, to device WTRU2 (16). The device WTRU2 may then send an ACK message to the SCC AS B confirming the removal of the media (17). The device WTRU2 and remote device WTRU may then update the media components information between themselves (18).

The device WTRU2 may send an update session controller and SCC AS A message regarding the session modifications to the SCC AS B (19), which in turn may send or forward the message to the SCC AS A (20). The SCC AS A may then forward or send the message to the device WTRU1 (21). The message may be sent via, for example, an UPDATE message. The device WTRU1 may then send a session modification update to the SCC AS A (22), which in turn may send or forward the message to the SCC AS B (23). The SCC AS B may then send or forward the message to the device WTRU2 (24). The media components remain unchanged between the device WTRU1 and the remote device WTRU (25).

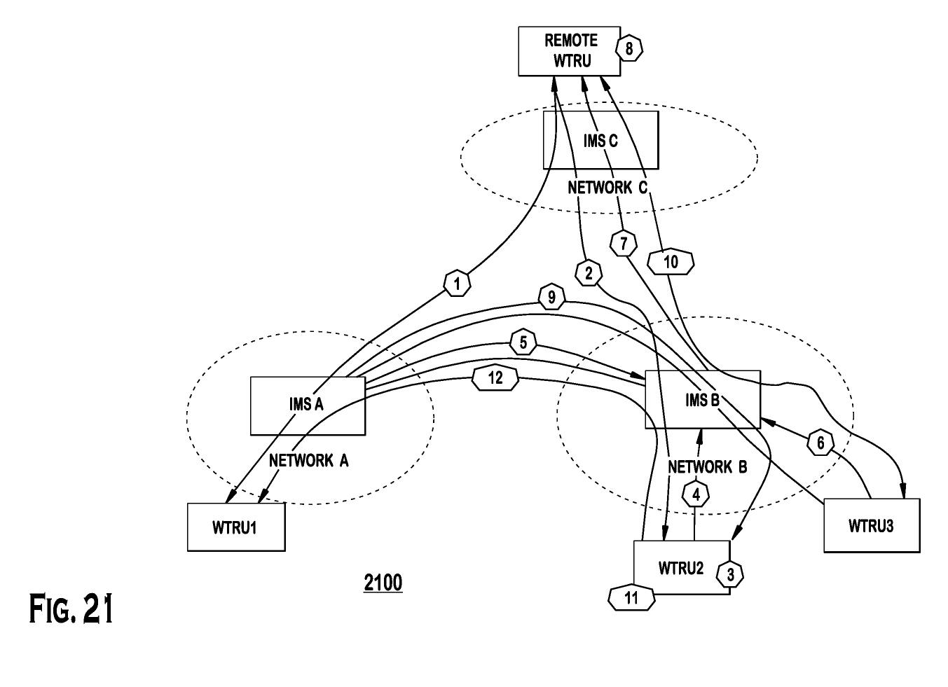

FIG. 21 shows an example diagram 2100 of a subsequent push based inter-operator IDT in a target operator using source operator signaling. Initially, a device WTRU1 is in a multimedia session with a remote device WTRU, where the session may include more than one media component (1). The device WTRU1 may be subscribed with network A and may interact with an IMS A, a device WTRU2 may be subscribed with a network B and may interact with an IMS B and a remote device WTRU may be subscribed with a network C and may interact with IMS C. The IMS A may include multiple entities including, for example, SCC AS A and call session control function (CSCF) A. The IMS B and C may be similar to the IMS A. The device WTRU1 may have established a collaborative session with the device WTRU2 by transferring some media components to the device WTRU2, where signaling may be anchored at a SCC AS A (2). The device WTRU2 may wish to transfer some media components from the device WTRU2 to a device WTRU3, where the device WTRU3 may be subscribed with network B (3). The device WTRU2 may check device WTRU3's availability for IDT and its media capabilities.

The device WTRU2 may initiate an IDT request towards device WTRU3 via a SCC AS B (4). Since the SCC AS A may be the anchor of the session and is involved in all signaling towards the remote device WTRU, the IDT request may be forwarded to the device WTRU3 via the SCC AS A and back through the SCC AS B (5). The device WTRU3 may request a media transfer by sending a request towards the remote device WTRU (6). The SCC AS B may initiate an update towards the remote device WTRU requesting that some media may be sent to the device WTRU3 (7). The remote device WTRU may accept the update and send back a response to acknowledge the session modification (8). The device WTRU3 may indicate a successful transfer of media via the SCC AS A (9). A new media path between the device WTRU3 and the remote device WTRU may be established (10). The transferred media components from the device WTRU2 may be removed (11). The device WTRU1, (the controller), and the SCC AS A may be updated regarding the media transfer (12).

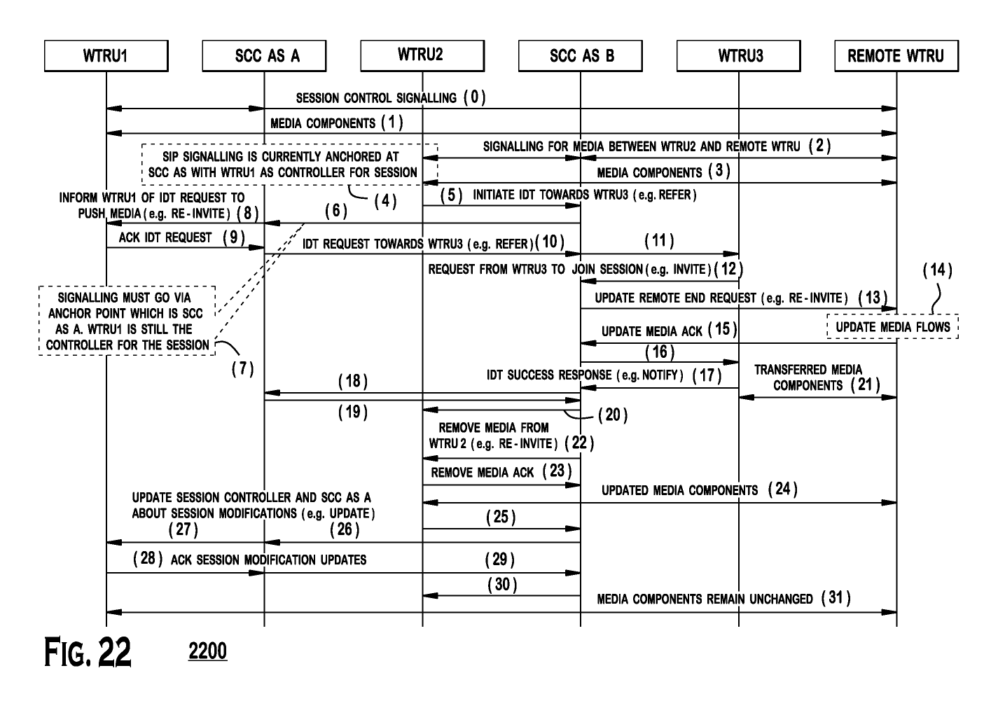

FIG. 22 shows an example flow diagram 2200 of a subsequent push based inter-operator IDT in a target operator using source operator signaling. Initially, there is an ongoing session between a device WTRU1 and a remote device WTRU, where the device WTRU1 and the remote device WTRU may send media components information between themselves (1). That is, the media flow may be unidirectional or bidirectional. The device WTRU1 may be subscribed to a network A. The ongoing or original session may be anchored at a SCC AS A and session control signaling between the device WTRU1 and the remote device WTRU may be done by the SCC AS A (0). The device WTRU1 may have established a collaborative session with a device WTRU2 by transferring some media components to the device WTRU2 (3), where signaling may be done via a SCC AS B (2). Session initiation protocol (SIP) signaling may be anchored at the SCC AS A with the device WTRU1 as the controller for the session (4).

The device WTRU2 may send an initiate IDT message towards the device WTRU3 via SCC AS B (5), which in turn sends or forwards the initiate message to SCC AS A (6). As noted earlier, the SCC AS A may be the anchor for the signaling and the device WTRU1 may be the controller for the session (7). The initiate IDT message may be sent using, for example, a REFER message. The SCC AS A may inform the device WTRU1 of the IDT request to push media (8). This may be done using, for example, a Re-INVITE message.

The device WTRU1 may send an ACK for the IDT request to the SCC AS A (9). The SCC AS A may send or forward the IDT request towards the device WTRU3 via the SCC AS B (10). This may be done using, for example, a REFER message. The SCC AS B may then forward the IDT request to the device WTRU3 (11). The device WTRU3 may send a request to the SCC AS B to join the session (12). The request may be sent using, for example, an INVITE message. The SCC AS B may then send an update remote end request to the remote device WTRU (13). This may be done using, for example, a Re-INVITE message. The remote device WTRU may then update the media flows (14) and may send an update media ACK to the SCC AS B (15), which may then forward the ACK to the device WTRU3 (16).

The device WTRU3 may then send an IDT success response to the SCC AS B (17), which in turn may send or forward the response to the SCC AS A (18). The SCC AS A then forwards the response to the SCC AS B (19), which in turn may send or forward the response to the device WTRU2 (20). The response may be sent via, for example, a NOTIFY message. At this time, the device WTRU3 and the remote device WTRU may transfer the media components information between themselves (21).

The SCC AS B may then remove the transferred media from the device WTRU2 by sending, for example, a Re-INVITE message, to device WTRU2 (22). The device WTRU2 may then send an ACK message to the SCC AS B confirming the removal of the media (23). The device WTRU2 and the remote device WTRU may then update the media components information between themselves (24).

The device WTRU2 may send an update session controller and SCC AS A message regarding the session modifications to the SCC AS B (25), which in turn may send or forward the message to the SCC AS A (26). The SCC AS A may then forward or send the message to the device WTRU1 (27). The message may be sent via, for example, an UPDATE message. The device WTRU1 may then send a session modification update ACK to the SCC AS A (28), which in turn may send or forward the ACK to the SCC AS B (29). The SCC AS B may then send or forward the ACK to the device WTRU2 (30). The media components remain unchanged between the device WTRU1 and the remote device WTRU (31).

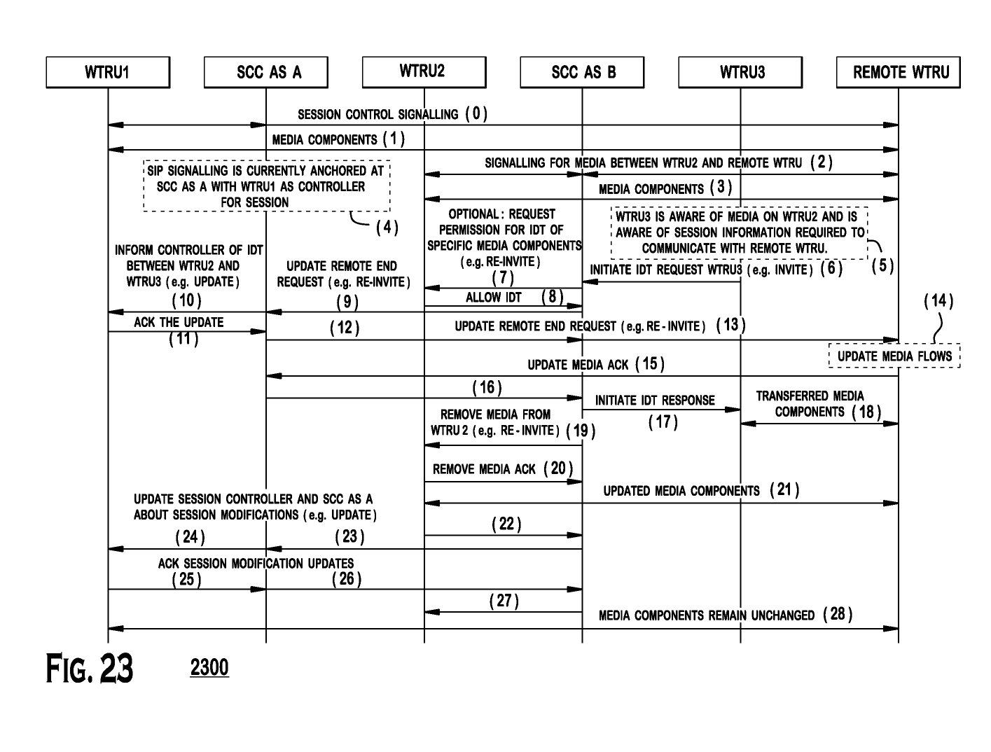

FIG. 23 shows an example flow diagram 2300 of a subsequent pull based inter-operator IDT in a target operator using source operator signaling. Initially, there is an ongoing session between a device WTRU1 and a remote device WTRU, where the device WTRU1 and the remote device WTRU may send media components information between themselves (1). That is, the media flow may be unidirectional or bidirectional. The device WTRU1 may be subscribed to a network A. The ongoing or original session may be anchored at a SCC AS A and session control signaling between the device WTRU1 and the remote device WTRU may be done by the SCC AS A (0). The device WTRU1 may have established a collaborative session with a device WTRU2 by transferring some media components to the device WTRU2 (3), where signaling may be done via a SCC AS B (2). Session initiation protocol (SIP) signaling may be anchored at the SCC AS A with the device WTRU1 as the controller for the session (4).

A device WTRU3 may be aware of media on the device WTRU2 and may be aware of session information needed to communicate with the remote device WTRU (5). The device WTRU3 may initiate an IDT request by sending, for example, an INVITE message to the SCC AS B (6). The SCC AS B may then request permission for an IDT of specific media components using, for example, a Re-INVITE message (7). The device WTRU2 may send a message allowing the IDT to the SCC AS B (8). The SCC AS B may then send an update remote end request to the SCC AS A (9). The SCC AS A may then inform the device WTRU1 of the IDT between the device WTRU2 and the device WTRU3 (10). This may be done using, for example, an UPDATE message. The device WTRU1 may send an ACK for the update request to the SCC AS A (11), which in turn may send or forward the ACK to the remote device WTRU (13) via the SCC AS B (12). This may be done using, for example, a Re-INVITE message. In effect, messages (9) and (12) are updates to the remote end sent via the SCC AS A and messages (10) and (11) are the update to the device WTRU1 to ensure that it is made aware of the subsequent IDT. In one example, the latter messages may be used for authorization of the IDT, where the authorization may be granted and then the update to the remote end continues as per message (12).

The remote device WTRU may then update the media flows (14) and may send an update media ACK to the SCC AS A (15), which may then forward the ACK to the SCC AS B (16). The SCC AS B may then initiate an IDT response to the device WTRU3 (17). The device WTRU3 and the remote device WTRU may then transfer the media components information between themselves (18). The SCC AS B may then remove the transferred media from the device WTRU2 by sending, for example, a Re-INVITE message, to the device WTRU2 (19). The device WTRU2 may then send an ACK message to the SCC AS B confirming the removal of the media (20). The device WTRU2 and the remote device WTRU may then update the media components information between themselves (21).

The device WTRU2 may send an update session controller and SCC AS A message regarding the session modifications to the SCC AS B (22), which in turn may send or forward the message to the SCC AS A (23). The SCC AS A may then forward or send the message to the device WTRU1 (24). The message may be sent via, for example, an UPDATE message. The device WTRU1 may then send a session modification update ACK to the SCC AS A (25), which in turn may send or forward the ACK to the SCC AS B (26). The SCC AS B may then send or forward the ACK to the device WTRU2 (27). The media components remain unchanged between the device WTRU1 and the remote device WTRU (28).

Additional subsequent IDTs with, for example, a device WTRU4 may be via a pull or a push mechanism. In general, updates to other entities involved in the session may be done using UPDATE or Re-INVITE messages. The latter message may be used if a change in the state of the dialog may occur. Alternatively, entities involved in the dialog may subscribe to the dialog event package at various entities, such as for example, at the controller.

In general, the initial session between a source device WTRU and a remote device WTRU may be anchored in the source network. Anchoring in a source network may be chosen upon creation of a collaborative session if the source device WTRU may be the controller. Anchoring in a target network but the source device WTRU remains the controller. The target device WTRU may be an IDT capable WTRU and thus all sessions for the target device WTRU may be anchored in the target network. The target device WTRU may act as a sub-controller for performing further inter-WTRU transfers, which may be transparent to the source network. Alternatively, full knowledge of such transfers may be provided to the session controller, (the source device WTRU).

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed is:

1. A method implemented at a source wireless transmit/receive unit (WTRU) for performing an inter-operator inter-device transfer (IDT), comprising:
transmitting an IDT request to transfer certain media to a target WTRU from an on-going session between the source WTRU and a remote WTRU, the target WTRU and the source WTRU being subscribed with different operators; and
establishing a collaborative session with at least the target WTRU for authorized transfer of the certain media.

2. The method of claim 1, further comprising:
acquiring information regarding the target WTRU.

3. The method of claim 1, wherein the IDT request is transmitted to a service centralization and continuity application server (SCC AS) corresponding to the source WTRU.

4. The method of claim 3, wherein the IDT request is transmitted to a SSC AS corresponding to the target WTRU.

5. The method of claim 1, wherein the target WTRU is uninvolved in the on-going session.

6. A method implemented at a server for performing an inter-operator inter-device transfer (IDT), comprising:
receiving an IDT request from a source wireless transmit/receive unit (WTRU) to transfer certain media to a target WTRU from an on-going session between the source WTRU and a remote WTRU, the target WTRU and the source WTRU being subscribed with different operators;
authorizing the IDT request; and
establishing a collaborative session between at least the target WTRU and the source WTRU with respect to the certain media.

7. The method of claim 6, further comprising:
transferring the certain media from the source WTRU to the target WTRU.

8. The method of claim 6, further comprising:
updating the remote WTRU with respect to transfer of the certain media; and
removing the certain media from the source WTRU.

9. The method of claim 6, wherein control of the collaborative session is with the server.

10. The method of claim 6, wherein the server is associated with the source WTRU and communicates with a second server associated with the target WTRU.

11. A method implemented at a target wireless transmit/receive unit (WTRU) for performing an inter-operator inter-device transfer (IDT), comprising:
transmitting an IDT request to transfer certain media to the target WTRU from an on-going collaborative session between a first WTRU, a source WTRU and a remote WTRU, wherein the first WTRU and the source WTRU are subscribed with different operators; and
updating the collaborative session with at least the target WTRU with respect to the certain media.

12. The method of claim 11, further comprising:
acquiring information regarding the on-going collaborative session.

13. The method of claim 11, further comprising:
receiving an IDT response in response to the IDT request.

14. The method of claim 11, wherein the IDT request is transmitted to at least one service centralization and continuity application server (SCC AS).

15. The method of claim 11, wherein the target WTRU is uninvolved in the on-going collaborative session.

16. A method implemented at a server for performing an inter-operator inter-device transfer (IDT), comprising:
receiving an IDT request to transfer certain media to a target WTRU from an on-going collaborative session between a first WTRU, a source WTRU and a remote WTRU, wherein the first WTRU and the source WTRU are subscribed with different operators;
transmitting the IDT request to the first WTRU;
receiving an acknowledgement from the first WTRU; and
updating the collaborative session with at least the target WTRU for the certain media.

17. The method of claim 16, further comprising:
updating the remote WTRU with respect to transfer of the certain media; and
removing the certain media from the source WTRU.

18. The method of claim 16, further comprising:
establishing a session with the target WTRU and transferring the certain media to the target WTRU from the source WTRU.

19. A method implemented at a target wireless transmit/receive unit (WTRU) for performing session discovery, comprising:
transmitting a capability and availability request to at least one WTRU involved in at least one on-going session, wherein the target WTRU and the at least one WTRU are subscribed with different operators; and
receiving an answer to the capability and availability request from the at least one WTRU.

20. A method implemented at a server for performing session discovery, comprising:
receiving a capability and availability request from a target wireless transmit/receive unit (WTRU);
transmitting the capability and availability request to at least one WTRU involved in at least one on-going session, wherein the target WTRU and the at least one WTRU are subscribed with different operators;
receiving an answer to the capability and availability request from the at least one WTRU; and
transmitting the answer to the target WTRU.
